(19) United States
(12) Patent Application Publication
(10) Pub. No.: US 2014/0081919 A1
(43) Pub. Date: Mar. 20, 2014

(54) DISTRIBUTED BACKUP SYSTEM FOR DETERMINING ACCESS DESTINATION BASED ON MULTIPLE PERFORMANCE INDEXES

(71) Applicants: Shinya Matsumoto, Tokyo (JP); Takaki Nakamura, Tokyo (JP); Masayuki Yamamoto, Tokyo (JP); Kazuhisa Fujimoto, Tokyo (JP)

(72) Inventors: Shinya Matsumoto, Tokyo (JP); Takaki Nakamura, Tokyo (JP); Masayuki Yamamoto, Tokyo (JP); Kazuhisa Fujimoto, Tokyo (JP)

(73) Assignee: HITACHI, LTD., Tokyo (JP)

(21) Appl. No.: 13/640,948

(22) PCT Filed: Sep. 20, 2012
(86) PCT No.: PCT/JP12/05971

§ 371 Date: Nov. 9, 2012

(51) Int. Cl. G06F 17/30

(52) U.S. Cl. 707/652; 707/E17.007

(57) ABSTRACT

A backup system having duplicated file system data and composed of a plurality of storage systems having different performances is provided, wherein a processing time required for backup of a small-sized file or an on-demand restoration of a file is reduced. A distributed backup system composed of a storage system and a plurality of backup units is equipped with a function for selecting a backup unit based on a plurality of performance indexes, and a requested data transfer size for performing backup or restoration is considered when performing the selection.

### TECHNICAL FIELD

The present invention relates to a backup method and a restoration method of a storage system for creating backup of data in multiple units.

### BACKGROUND ART

Information systems are used in various areas of businesses, such as mission-critical systems of enterprises, banking systems, and electronic commercial transactions. There are demands regarding such systems to reduce failure of systems and service outage time caused by failure.

In order to respond to such demands, on-demand restoration is proposed in the field of storage technology. On-demand restoration refers to restoring data from a backup unit for the first time when an application or a storage system user such as an end user uses the data. The on-demand restoration technique no longer requires the operation of restoring all the data in the storage system prior to resuming service that had been required according to the prior art technique, according to which the service outage time can be reduced.

A distributed backup system is used to create backup of data in a plurality of storage systems for enhancement of fault tolerance and for higher performance. A distributed backup system stores data in a redundant manner by replicating a single data into multiple backup units. There are demands to perform backup and restoration of data at high speed in such distributed backup system.

One means for satisfying such request is disclosed in patent literature 1 teaching a method for performing backup and restoration, wherein during backup of a database, an optimum backup unit is selected from a plurality of backup units based on a selection condition set in advance. If there are backup units having different performances, the selection condition should be set for example as follows; “rate (bandwidth) of connection circuit is higher than given threshold”, so that a unit having a high connection circuit speed (bandwidth) is selected from a plurality of units to perform backup and restoration. Thus, the time required to perform backup and restoration of a large amount of data, possibly causing the rate of the connection circuit (bandwidth) to become a bottleneck of the performance, can be shortened.

### CITATION LIST

### Patent Literature

PTL 1: Japanese Patent Application Laid-Open Publication No. 2005-004243

### SUMMARY OF INVENTION

### Technical Problem

However, according to the method disclosed in the above-described patent literature 1, optimum backup unit cannot be selected when backup of a small-size data or on-demand restoration of a file is performed.

According to the backup and restoration method of a file system adopted in the prior art, the storage system performs transmission and reception of an archive file having assembled the whole file system with the backup unit. In general, the size of an archive file is large, possibly reaching a few GB to even a few TB.

In contrast to the above-described conventional backup, in order to perform backup of a single file unit, a small-sized file of approximately a few KB is transmitted to the backup unit. Further, compared to the prior art restore processing, in the on-demand restore processing of a file, small-sized data of approximately a few KB is often restored via a single restore processing. For example, if the user of the storage system accesses only a portion of the metadata or data of a file, the storage system must restore only a few KB of data that the user wishes to access from the backup unit.

Generally, upon transferring small-sized data of approximately a few KB, the transfer time will not change by whether a path having a large bandwidth is used or a path having a small bandwidth is used. A large portion of the time required for transferring small-sized data is consumed by the time required for protocol processing, and not by the time required for transferring the data. Therefore, according to the method taught in patent literature 1 in which the unit is selected based on bandwidth, it is not possible to select an optimum unit suitable for backup of single file-unit data or on-demand restoration of a file.

Therefore, the problem to be solved according to the present invention is to shorten the processing time required for performing file-unit backup or for performing file-unit restoration by selecting a system suitable for performing backup or on-demand file restoration in a backup system having redundant file system data.

### Solution to Problem

In order to solve the problem of the prior art, the present invention provides a distributed backup system comprising a plurality of backup units, and a storage system capable of selecting the backup units, wherein the storage system retains a response time and a bandwidth of each backup unit, and when selecting a backup unit set as a transmission source for performing restoration, determines whether a transfer size of data being the target of the restore request exceeds a given threshold or not, and if the size exceeds the threshold as a result of the determination, selects the backup unit based on the bandwidth, whereas if the size falls below the threshold as a result of the determination, selects the backup unit based on the response time.

### Advantageous Effects of Invention

The present invention enables to enhance the speed of backup of a small-sized file and the speed of on-demand restoration, according to which the processing time can be shortened.

### BRIEF DESCRIPTION OF DRAWINGS

FIG. 1 is a block diagram illustrating an example of configuration of a distributed backup system according to a first embodiment of the present invention.

FIG. 2 is a block diagram illustrating a configuration of a storage system 200 according to embodiment 1.

FIG. 3 is a block diagram illustrating a configuration of one backup unit out of multiple units 300 according to embodiment 1.

FIG. 4 is a block diagram showing a configuration of a file server program 400 according to embodiment 1.

FIG. 5 is a block diagram showing a configuration of a file operation program 500 according to embodiment 1.

FIG. 6 is a block diagram showing a configuration of a backup program 600 according to embodiment 1.

FIG. 7 is a block diagram showing a configuration of an on-demand restore program 700 according to embodiment 1.

FIG. 8 is a block diagram showing a configuration of a backup unit selection program 800 according to embodiment 1.

FIG. 9 is a block diagram showing a configuration of a backup unit management program 900 according to embodiment 1.

FIG. 10 is a block diagram showing a configuration of an object server program 1000 according to embodiment 1.

FIG. 11 is a block diagram showing a configuration of an object operation program according to embodiment 1.

FIG. 12 is a view showing one example of a restore progress management table 1200 according to embodiment 1.

FIG. 13 is a view showing one example of a unit selection condition setup table 1300 according to embodiment 1.

FIG. 14 is a view showing one example of a configuration definition table 1400 according to embodiment 1.

FIG. 15 is a view showing one example of an object allocation management table 1500 according to embodiment 1.

FIG. 16 is a view showing one example of a performance measurement table 1600 according to embodiment 1.

FIG. 17 is a view showing one example of a unit selection condition setup screen 1700 according to embodiment 1.

FIG. 18 is a flow of processing of a backup module 603 according to embodiment 1.

FIG. 19 is a flow of processing of a unit selection module 804 when a backup is acquired according to embodiment 1.

FIG. 20 is a flow of processing of a restore module 703 according to embodiment 1.

FIG. 21 is a flow of processing of a unit selection module 804 during restoration processing according to embodiment 1.

FIG. 22 is a flow of processing of the unit selection module 804 during acquisition of backup according to embodiment 2.

FIG. 23 is a flow of processing of the unit selection module 804 during restoration processing according to embodiment 2.

FIG. 24 is a view showing one example of a performance measurement table 2400 according to embodiment 3.

FIG. 25 is a flow of processing of a backup module 603 according to embodiment 3.

FIG. 26 is a flow of processing of a unit selection module 804 during acquisition of backup according to embodiment 3.

FIG. 27 is a flow of processing of a restore module 703 according to embodiment 3.

FIG. 28 is a flow of processing of a unit selection module 804 during restoration processing according to embodiment 3.

FIG. 29 is a view showing one example of an object allocation management table 2900 according to embodiment 4.

FIG. 30 is a view showing one example of a restore progress management table 3000 according to embodiment 4.

FIG. 31 is a flow of processing of a restore module 703 according to embodiment 4.

FIG. 32 is a block diagram illustrating an example of configuration of a distributed backup system according to embodiment 5.

FIG. 33 is a block diagram illustrating a configuration of a relay storage system 3300 according to embodiment 5.

FIG. 34 is a block diagram illustrating a configuration example of a relay restore program 3400 according to embodiment 5.

FIG. 35 is a view showing one example of a configuration definition table 3500 according to embodiment 5.

FIG. 36 is a view showing one example of a performance measurement table 3600 according to embodiment 5.

FIG. 37 is a part of a flow of processing of the restore module 703 according to embodiment 5.

FIG. 38 is a part of a flow of processing of the restore module 703 according to embodiment 5.

FIG. 39 is a flow of processing of a relay restore module 3404 according to embodiment 5.

### DESCRIPTION OF EMBODIMENTS

Now, the preferred embodiment of the present invention will be described, taking as an example a system for performing distributed backup of a file system stored in a single storage system into three backup units.

### Embodiment 1

In embodiment 1, the system determines whether or not the size of the data being transferred exceeds a predetermined threshold upon accessing a backup unit used for performing backup or restoration of a file system, and if the data size exceeds the threshold, a backup unit having the maximum bandwidth is selected as the communication destination, and if the data size is smaller than the threshold, a backup unit having the minimum response time is selected as the communication destination. Such function for selecting a backup unit is installed in a storage system acting as a backup source or a restore destination.

Now, the first embodiment of the present invention will be described in detail.

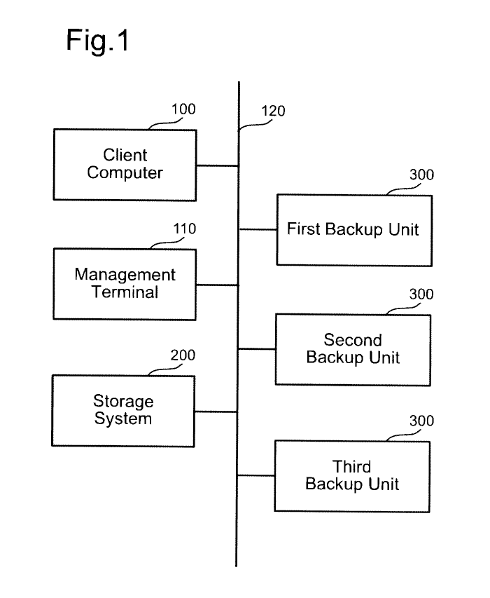

FIG. 1 is a block diagram illustrating a configuration example of a distributed backup system according to the present embodiment.

A client computer 100 is a computer utilized by an end user using a file sharing service provided by a storage system 200.

A management computer 110 is a computer for managing the storage system 200 and the n-th backup unit 300 (wherein n=1, 2, 3). The management computer 110 is used by an administrator managing the storage system 200 and the n-th backup unit 300 (wherein n=1, 2, 3).

The storage system 200 is a computer for providing the file sharing service to the client computer 100. Further, the storage system 200 performs backup of data to multiple backup units 300. Further, the storage system restores data from multiple backup units 300 (wherein n=1, 2, 3).

Multiple backup units 300 is a computer for providing a backup service of files to the storage system 200.

A network 120 is a network for mutually connecting the client computer 100, the management computer 110, the storage system 200 and multiple backup units 300. The network 120 can be, for example, a LAN (Local Area Network) or a SAN (Storage Area Network).

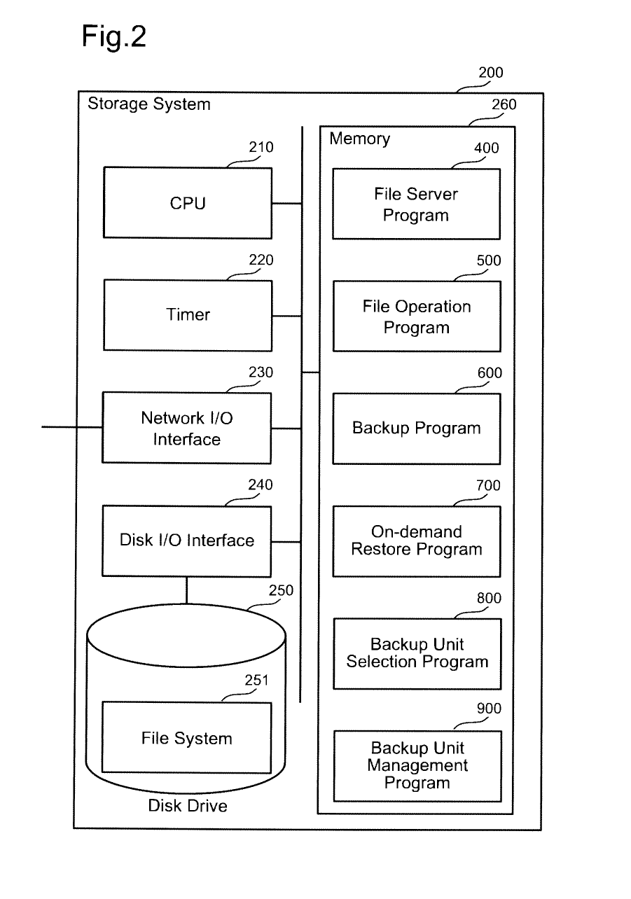

FIG. 2 is a block diagram illustrating a configuration of the storage system 200.

The storage system 200 is a computer having a CPU 210, a timer 220, a network I/O interface 230, a disk I/O interface 240, a disk drive 250, a memory 260, and an internal communication channel (such as a bus) connecting the same.

The CPU 210 executes programs stored in the memory 260. The timer 220 executes programs periodically. The network I/O interface 230 is used for the communication among the client computer 100, the management computer 110 and multiple backup units 300. The disk I/O interface 240 is used for the communication with the disk drive 250. The disk drive 250 is used for storing the data read from or written to the storage system 200, and stores a file system 251. The file system 251 is a system for managing files hierarchically using directories. The memory 260 stores programs and data. For example, it stores a file server program 400, a file operation program 500, a backup program 600, an on-demand restore program 700, a backup unit selection program 800 and a backup unit management program 900.

The file server program 400 is a program for providing a file sharing service to the client computer 100. The program can be, for example, an NFS (Network File System) server program or a CIFS (Common Internet File System) server program.

The file operation program 500 is a program for operating files and directories stored in the file system 251.

The backup program 600 is a program for replicating files and directories into the multiple backup units 300.

The on-demand restore program 700 is a program for reconstructing files and directories in the storage system 200 using the data stored in the multiple backup units 300. The on-demand restore program 700 enables the client computer 100 to access data transparently by storing the information indicating the data location stored in the multiple backup units 300 to the storage system 200, and when data is requested from the client computer 100, the requested data is restored from the multiple backup units 300 to the storage system 200.

The backup unit selection program 800 is a program for selecting a backup unit for performing communication during backup and restore operations from the multiple backup units 300.

The backup unit management program 900 is a program for managing the accessible backup unit, the allocation of data and the performance of the system.

A disk drive has been illustrated as a data storage media used by the storage system 200, but a SSD (Solid State Drive) can also be used. Moreover, a system having a data storage media built therein has been illustrated as the storage system 200, but an external storage system can also be adopted. For example, a disk array system connected via a SAN (Storage Area Network) can be used.

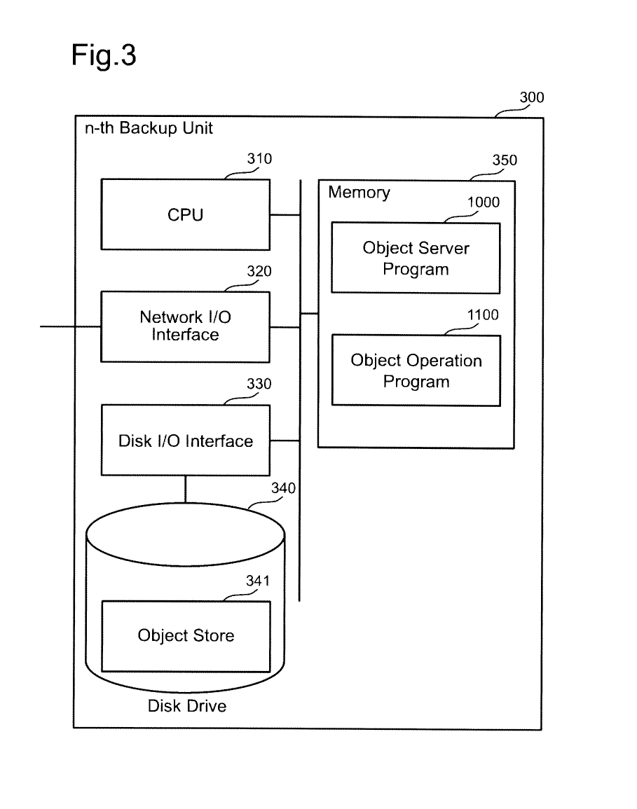

FIG. 3 is a block diagram illustrating a configuration of an n-th backup unit composed as one of the multiple backup units 300.

The n-th backup unit 300 is a computer having a CPU 310, a network I/O interface 320, a disk I/O interface 330, a disk drive 340, a memory 350, and an internal communication channel (such as a bus) connecting the same.

The CPU 310 executes programs stored in the memory 350. The network I/O interface 320 is used for the communication between the management computer 110 and the storage system 200. The disk I/O interface 330 is used for the communication with the disk drive 340. The disk drive 340 is used for storing the data read or written by the n-th backup unit 300, and an object storage 341 is stored therein. The object storage 341 is a system for managing data as objects. The memory 350 stores programs and data. For example, it stores an object server program 1000 and an object operation program 1100.

The object server program 1000 is a program for providing a storage service in object units to the storage system 200. The program provides a storage service using HTTP (Hypertext Transfer Protocol) or HTTPS (Hypertext Transfer Protocol over Secure Socket Layer) as interface.

The object operation program 1100 is a program for operating the object stored in the object storage 341.

A disk drive has been illustrated as the data storage medium used in the multiple backup units 300, but an SSD (Solid State Drive) can also be used. A system having data storage media built therein has been illustrated as the storage system 200, but the system can also adopt an external storage system. For example, the system can use a disk array unit coupled via a SAN (Storage Area Network).

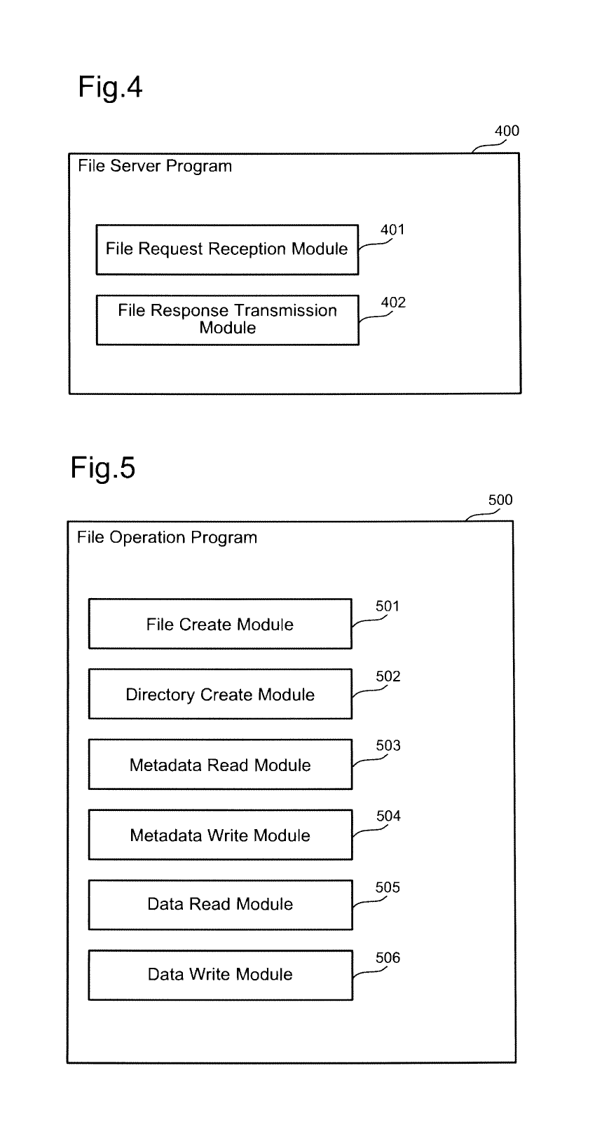

FIG. 4 is a block diagram illustrating the configuration of the file server program 400.

The file server program 400 comprises a file request reception module 401 and a file response transmission module 402.

The file request reception module 401 is executed when a file operation request is received from the client computer 100 or the storage system 200. A file operation request is any one of the following: a file create request, a directory create request, a metadata read request, a metadata write request, a data read request, or a data write request. The file request reception module 401 transmits the received file operation request to the file operation program 500.

The file response transmission module 402 responds the processing result of the file operation request received from the file operation program 500 to the client computer 100 or the storage system 200.

FIG. 5 is a block diagram illustrating the configuration of a file operation program 500. The file operation request includes a path showing the location of the file or the directory stored in the file system 251. For example, a path is a character string divided via diagonals, an example of which is the following: /mnt/filesystem/dir/file.txt.

The file operation program 500 includes a file create module 501, a directory create module 502, a metadata read module 503, a metadata write module 504, a data read module 505, and a data write module 506.

The file create module 501 is executed when a file create request is received, based on which a file is created to a path designated by the issue source of the request, and thereafter, a response is transmitted to the file server program 400 regarding whether the process has succeeded or not.

The directory create module 502 is executed when a directory create request is received, based on which a directory is created to a path designated by the issue source of the request, and thereafter, a response is transmitted to the file server program 400 regarding whether the process has succeeded or not.

The metadata read module 503 is executed when a metadata read request is received, based on which the metadata of the file or the directory of the path designated by the issue source of the request is read, and thereafter, a response is transmitted to the file server program 400 regarding whether the process has succeeded or not, and if the process has succeeded, the contents of the read attribute. If the target is a directory, a list of paths to the files stored in the directory or the paths to the directory are also read.

The metadata write module 504 is executed when a metadata write request is received, based on which the designated metadata is written to the file or the directory of the path designated by the issue source of the request, and thereafter, a response is transmitted to the file server program 400 regarding whether the process has succeeded or not. If the target is a directory, the addition of paths or renaming of paths to files stored in the directory or to the directory are performed.

The data read module 505 is executed when a data read request is received, based on which the contents of a file is read from the file having a path designated by the issue source of the request, and thereafter, a response is transmitted to the file server program 400 regarding whether the process has succeeded or not, and if the process has succeeded, the contents of the read data.

The data write module 506 is executed when a data write request is received, based on which the contents of a file is written to the file having a path designated by the issue source of the request, and thereafter, a response is sent to the file server program 400 on whether the process has succeeded or not.

The file operation program 500 issues a restore request to the on-demand restore program 700 to confirm whether data required for file operation is stored in the file system 251 or not. After receiving a restore response from the on-demand restore program 700 and having all the data required for file operation restored in the file system 251, the file operation request is processed. Data required for file operation refers to all files and/or directories shown in the path of the file or the directory. For example, when a file create request of /mnt/filesystem/dir/file.txt is received, the data required for file operation are the following three directories: /mnt, /mnt/filesystem, and /mnt/filesystem/dir/. The file operation program 500 sends restore requests of the three directories, which are /mnt, /mnt/filesystem, and /mnt/filesystem/dir/ to the on-demand restore program 700. After the on-demand restore program 700 completes restoring the /mnt/filesystem/die, the file operation program 500 starts file creation of /mnt/filesystem/dir/file.txt.

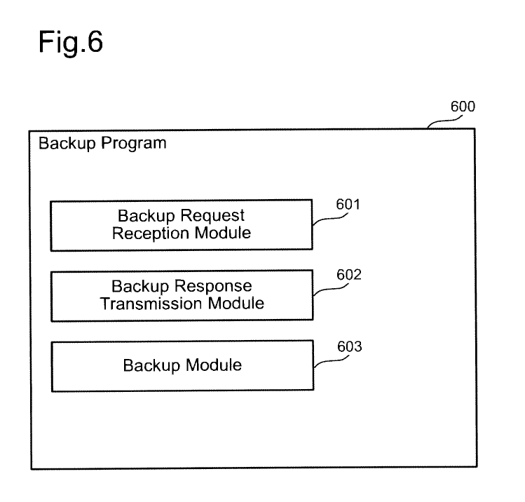

FIG. 6 is a block diagram illustrating a configuration of a backup program 600.

The backup program 600 includes a backup response reception module 601, a backup response transmission module 602 and a backup module 603.

The backup response reception module 601 is executed when a backup request is received from the management computer 110 or the timer 220, and the received backup request is transmitted to the backup module 603.

The backup response transmission module 602 sends the result of processing of the backup request received from the backup module 603 to the management computer 110 or the timer 220.

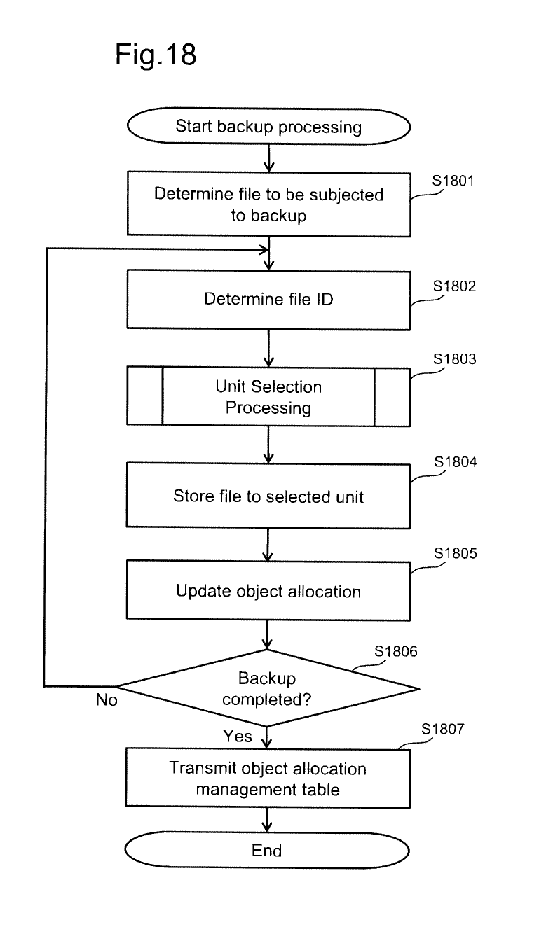

The backup module 603 is executed when a backup request is received, wherein the files or the directories stored in the file system 251 are backed up in the n-th backup unit 300. The details of the process performed by the backup module 603 will be described later with reference to FIG. 18.

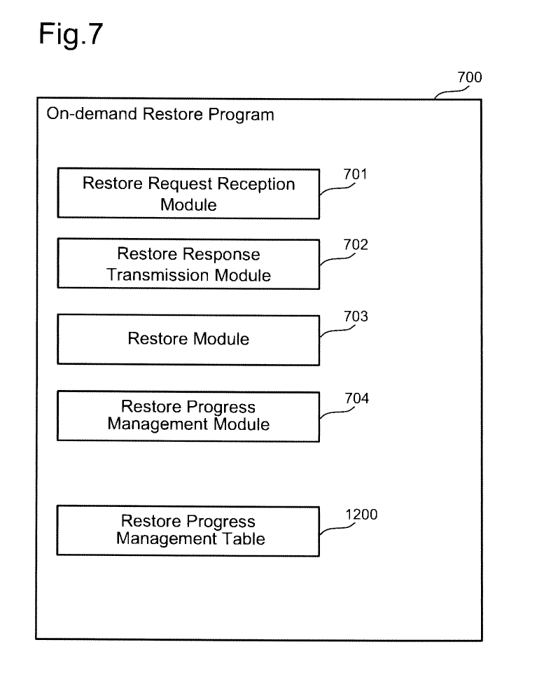

FIG. 7 is a block diagram illustrating the configuration of an on-demand restore program 700.

The on-demand restore program 700 includes a restore request reception module 701, a restore response transmission module 702, a restore module 703, a restore progress management module 704, and a restore progress management table 1200.

The restore request reception module 701 is executed when a restore request is received from the management computer 110 or the file operation program 500, and the received restore request is transmitted to the restore module 703.

The restore response transmission module 702 responds the result of processing of the restore request received from the restore module 703 to the management computer 110 or the file operation program 500.

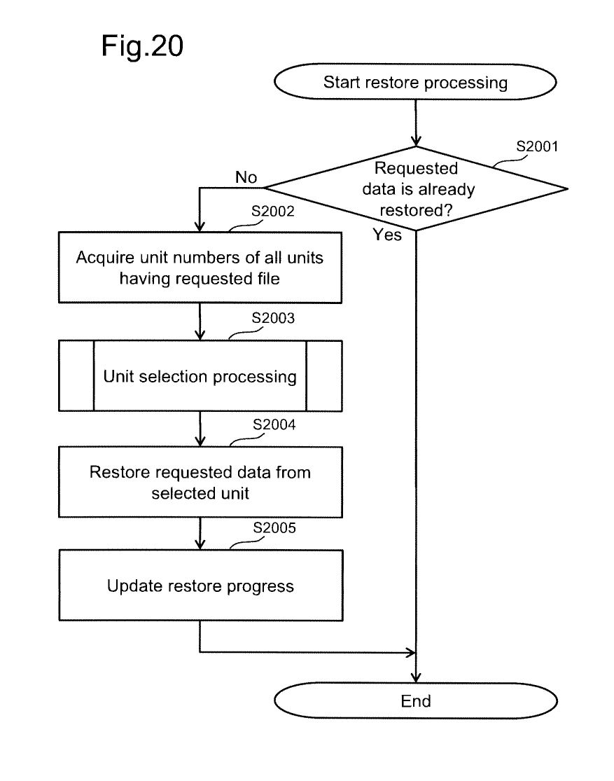

The restore module 703 is executed when a restore request is received from the restore request reception module 701, according to which files and directories are restored to the file system 251 from the object stored in the multiple backup units 300. The details of the processing performed in the restore module 703 will be described later with reference to FIG. 20.

The restore progress management module 704 is executed by the restore module 703, and manages whether or not the restoration of files and directories to be stored to the file system 251 has been completed or not.

The restore progress management table 1200 is operated from the restore progress management module 704, and the status of progress of the restoration is stored.

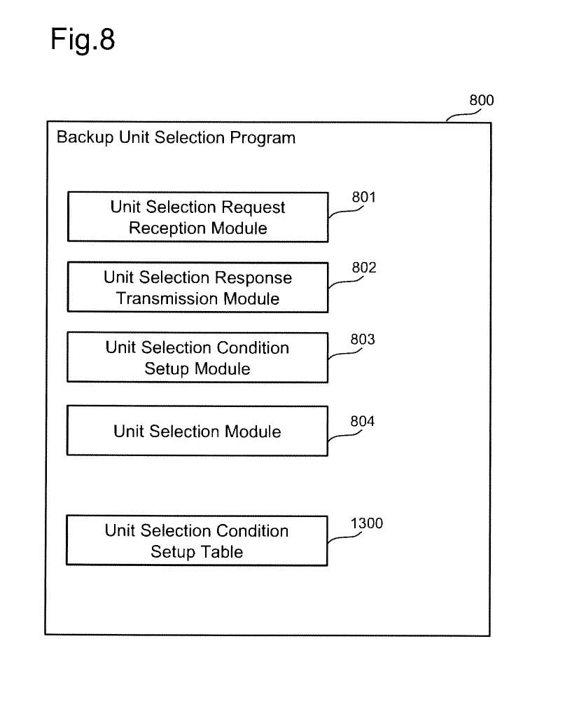

FIG. 8 is a block diagram illustrating a configuration of a backup unit selection program 800.

The backup unit selection program 800 includes a unit selection request reception module 801, a unit selection response transmission module 802, a unit selection condition setup module 803, a unit selection module 804, and a unit selection condition setup table 805.

The unit selection request reception module 801 is executed when a unit selection condition setup request is sent from the management computer 110 or when a unit selection request is sent from the backup program 600 or the on-demand restore program 700, based on which the unit selection condition setup request is transmitted to the unit selection condition setup module 803 and the unit selection request is transmitted to the unit selection module 804.

The unit selection response transmission module 802 sends the result of processing of the unit selection condition setup request received from the unit selection condition setup module 803 to the management computer 110, and sends the result of processing of the unit selection request received from the unit selection module 804 to the backup program 600 or the on-demand restore program 700 as response.

The unit selection condition setup module 803 is executed when a unit selection condition setup request is received, and the conditions for selecting units are set up in a unit selection condition setup table 1300.

The unit selection module 804 is executed when a unit selection request is received, and a unit is selected based on the set unit selection condition (such as the unit selection condition setup table 1300) and the unit information (such as a configuration definition table 1400, an object allocation management table 1500, and a performance measurement table 1600 described later).

The unit selection condition setup table 1300 is manipulated from the unit selection condition setup module 803, and stores conditions used for selecting units.

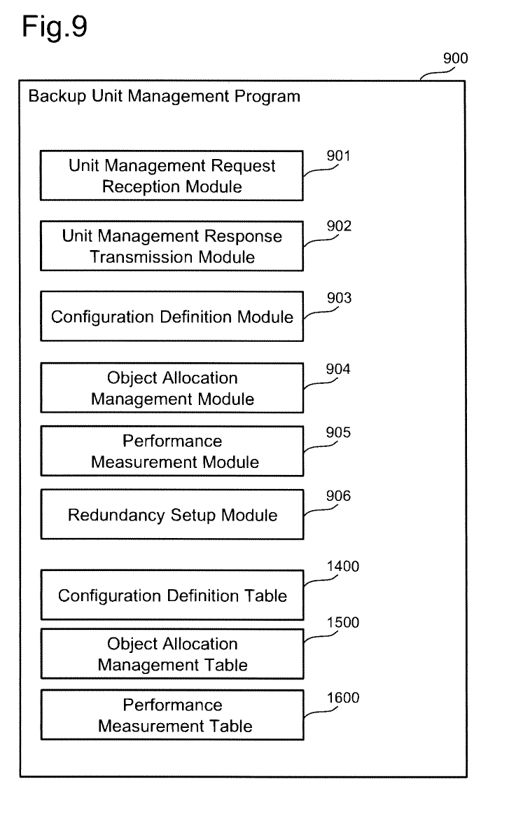

FIG. 9 is a block diagram illustrating a configuration of a backup unit management program 900.

The backup unit management program 900 includes a unit management request reception module 901, a unit management response transmission module 902, a configuration definition module 903, an object allocation management module 904, a performance measurement module 905, a redundancy setup module 906, a configuration definition table 1400, an object allocation management table 1500, and a performance measurement table 1600.

The unit management request reception module 901 is executed when a unit management request is transmitted from the management computer 110, the timer 220, the backup program 600, the on-demand restore program 700 or the backup unit selection program 800. At this time, the unit management request refers to one of the following: a configuration update request, an object allocation update request, a performance update request, a configuration reference request, a performance reference request, an object allocation reference request, or an object allocation recovery request. The configuration update request and the object allocation recovery request are transmitted from the management computer 110. The performance update request is periodically transmitted from the timer 220. The object allocation update request is transmitted from the backup program 600. The configuration reference request, the performance reference request and the object allocation reference request are transmitted from the backup program 600, the on-demand restore program 700 and the unit selection program 800.

The unit management request reception module 901 transmits a unit management request to an appropriate module, wherein the configuration update request and the configuration reference request are transmitted to the configuration definition module 903, the object allocation update request and the object allocation reference request are transmitted to the object allocation management module 904, and the performance update request and the performance reference request are sent to the performance measurement module 905.

The unit management response transmission module 902 transmits the result of processing the unit management request received from the configuration definition module 903, the object allocation management module 904 and the performance measurement module 905 to a request transmission source terminal, timer or program as response.

The configuration definition module 903 is executed when a configuration update request or a configuration reference request is received, wherein when a configuration update request is received, the configuration definition table 1400 is updated and the result is transmitted to the unit management response transmission module 902, and when a configuration reference request is received, the information of the configuration definition table 1400 is read and the result is transmitted to the unit management response transmission module 902.

The object allocation management module 904 is executed when an object allocation update request, an object allocation reference request or an object allocation recovery request is received, wherein when an object allocation update request is received, the object allocation management table 1500 is updated and the result is sent to the unit management response transmission module 902, when an object allocation reference request is received, the object allocation management table 1500 is read and the result is sent to the unit management response transmission module 902, and when an object allocation recovery request is received, the object allocation management table 1500 is read by communicating with one or a plurality of backup units, and the object allocation management table 1500 is restored to the memory 260.

The performance measurement module 905 is executed when a performance update request or a performance reference request is received, wherein when a performance update request is received, test data is transmitted to and received from the multiple backup units 300, by which the performance of each backup unit is measured, and wherein the performance measurement table 1600 is updated by setting the result of measurement using a file having a small size (such as 4 KB) as test data as a response time and setting the result of measurement using a file having a large size (such as 100 MB) as test data as a bandwidth, the result of which is transmitted to the unit management response transmission module 902. When a performance reference request is received, the performance measurement table 1600 is read, and the result is transmitted to the unit management response transmission module 902. The performance measurement module 905 is executed periodically via a performance update request sent periodically from the timer 220, such as via a frequency of once every 10 minutes.

The redundancy setup module 906 is executed when providing redundancy during acquisition of backup. That is, redundancy is set as (number of backup+1).

The configuration definition table 1400 is operated from the configuration definition module 903, and stores the access destination of the multiple backup units 300.

The object allocation management table 1500 is operated from the object allocation management module 904, and manages the storage destination of files.

The performance measurement table 1600 is operated from the performance measurement module 905, and stores the performance values of each unit with respect to a plurality of performance indexes.

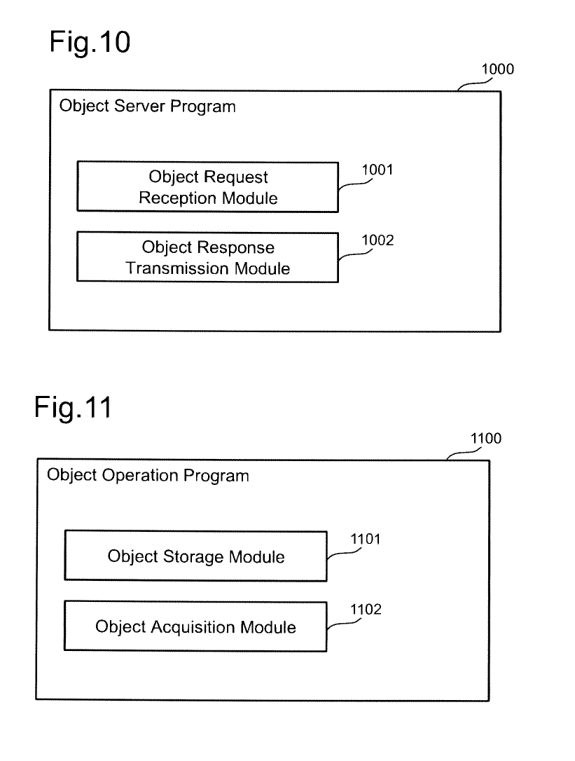

FIG. 10 is a block diagram illustrating the configuration of an object server program 1000.

The object server program 1000 is equipped with an object request reception module 1001 and an object response transmission module 1002.

The object request reception module 1001 is executed when an object operation request is output from the storage system 200, and the received object operation request is transmitted to the object operation program 1100. The object operation request is either an object storage request or an object acquisition request.

The object response transmission module 1002 sends the result of processing of the object operation request received from the object operation program 1100 as response to the storage system 200.

FIG. 11 is a block diagram illustrating a configuration of an object operation program 1100. The object operation request includes an UUID (Universally Unique Identifier) illustrating a location of an object stored in the object storage 341. The UUID is a random character string having a fixed length, such as “e46367”, “e858b7” and “749bdb”.

The object operation program 1100 includes an object storage module 1101 and an object acquisition module 1102.

The object storage module 1101 is executed when an object storage request is received, according to which the contents included in the object storage request is associated with the UUID included in the object storage request and stored in the object storage 341. At this time, the content data and metadata are stored as individual associated UUID objects. Now, what is meant by individual associated UUID is that if the UUID associated with the data is referred to as “e46367”, the UUID associated with the metadata is referred to as “e46367_metadata”. Thereafter, the object storage module 1101 responds whether the process has succeeded or not to the object server program 1000.

The object acquisition module 1102 is executed when an object acquisition request is received, wherein the object associated to the UUID included in the object acquisition request is read from the object storage 341, and thereafter, whether the process has succeeded or not, and if the process has succeeded, the contents having been read is sent as response to the object server program 1000.

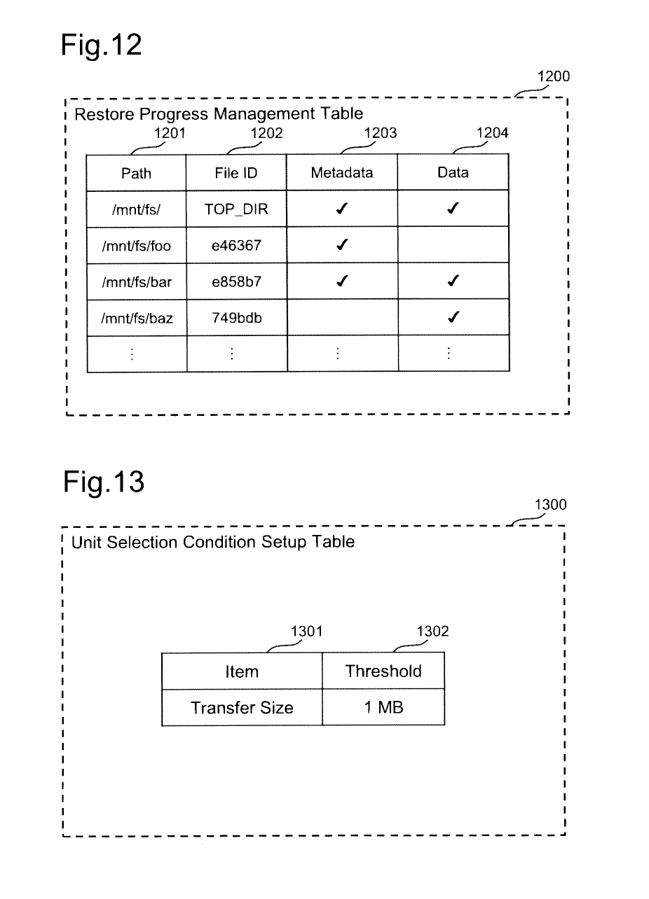

FIG. 12 is a view showing one example of a restore progress management table 1200.

The entry of the restore progress management table 1200 is composed of a path 1201, a file ID 1202, a metadata 1203 and data 1204.

The path 1201 stores paths of each file or each directory stored in the file system 251.

The file ID 1202 stores unique IDs associated with each file or each directory stored in the file system 251. A UUID is shown as an example of the value to be stored in the file ID 1202, but names or paths of files or directories can be stored instead. Now, the file ID value “TOP_DIR” denotes the uppermost directory of the file system.

The metadata 1203 stores the information on whether the metadata of the file or the directory has been restored or not. If a checkmark is entered in the metadata 1203, it means that metadata of a file or a directory exists within the file system 251. If there is no entry in the metadata 1203 column, it means that the metadata of a file or a directory does not exist within the file system 251. A value showing whether a metadata unit exists or not is stored as the metadata 1203, but it is also possible to have a value showing whether a portion of metadata exists or not stored as metadata 1203. For example, it may be possible to store whether a portion of the metadata in units of file size, read time, update time or access control information (such as permission, ACL (Access Control List) or ACE (Access Control Entry)) exists or not, or whether a specific offset unit of metadata exists or not.

The data 1204 stores information on whether the file data has been restored or not. If a checkmark is entered in the data 1204, it means that file data exists in the file system 251. If there is no entry in the data 1204 column, it means that file data does not exist in the file system 251. An example of showing whether all data exists or not as the value of data 1204 has been illustrated, but whether a portion of the data exists or not can be shown instead. For example, it is possible to store an offset that data exists in the file system 251. Since a directory has no data, a checkmark is always entered in the data 1204 column.

FIG. 13 is a view showing one example of a unit selection condition setup table 1300.

The entries of the unit selection condition setup table 1300 include an item 1301 and a threshold 1302.

The item 1301 stores an item used as the condition for selecting units. A transfer size showing the size of a file or a directory to be transmitted to the backup unit is shown as an example of the value of item 1301, but metadata of files or directories (such as the file size, the read time, the update time or the access control information) can also be set.

The threshold 1302 stores the value used as the threshold of the item used for the condition of selecting units. 1 MB has been shown as the value of threshold 1302, but it is possible to have an appropriate value for each item stored in the threshold. For example, if the item is the read time or the update time of a file or a directory, a clock time such as “2012-04-01 12:00”, or a UNIX (Registered Trademark) time which shows the time from the number of seconds from a certain date and time, such as “1333540800”, can be stored. If the item is the access control information of a file or a directory, a value such as “the owner has the read authority” can be stored.

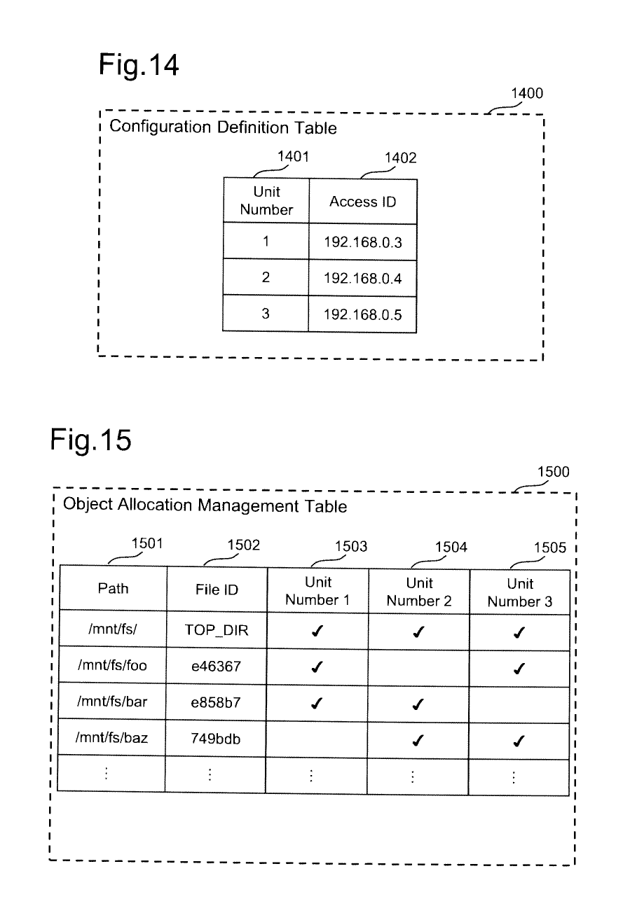

FIG. 14 is a view showing one example of a configuration definition table 1400.

The configuration definition table 1400 is composed of a unit number 1401 and an access ID 1402.

The unit number 1401 stores a unique number assigned to the backup unit.

The access ID 1402 stores the necessary ID for accessing the backup unit. An IPv4 (Internet Protocol version 4) address has been illustrated as a value of access ID 1402, but other values such as an IPv6 (Internet Protocol version 6) address or a DNS (Domain Name Server Name) can be stored.

FIG. 15 is a view showing one example of an object allocation management table 1500.

The object allocation management table 1500 is composed of a path 1501, a file ID 1502, and unit numbers 1503, 1504 and 1505.

The path 1501 stores the paths of each file or each directory stored in the file system 251.

The file ID 1502 stores a unique ID associated with each file or each directory stored in the file system 251. A UUID is shown as a value stored in the file ID 1502, but a name or a path of a file or a directory can be stored instead. Now, the file ID value “TOP_DIR” refers to the uppermost directory of the file system.

The unit numbers 1503, 1504 and 1505 store the information on whether a file or a directory has been backed up to the backup unit shown by each unit number. “Unit number 1” of unit number 1503 corresponds to the first backup unit, “unit number 2” of unit number 1504 corresponds to the second backup unit, and “unit number 3” of unit number 1505 corresponds to the third backup unit. For example, if a checkmark is entered in the unit number 1503, it means that the backup of the file or the directory exists in the first backup unit 300. When the unit number 1503 is vacant, it means that the backup of the file or the directory does not exist in the first backup unit 300. The same applies for unit number 1504 and unit number 1505.

The object allocation management table 1500 stores information related to the object allocation of all backup units, and is updated when a backup is created. According to embodiment 1, there are three backup units, so that the information related to only unit numbers 1, 2 and 3 is stored. When there are 10 backup units, the information related to units numbers 1 through 10 is stored.

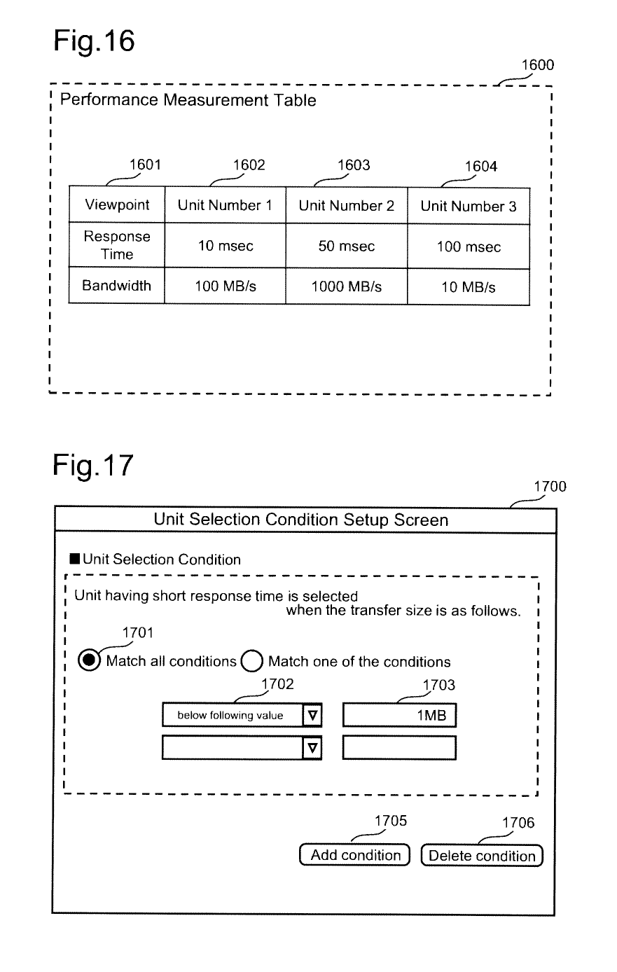

FIG. 16 illustrates one example of a performance measurement table 1600.

The performance measurement table 1600 includes a viewpoint 1601, and unit numbers 1602, 1603 and 1604.

The viewpoint 1601 stores the name of an index used for performance measurement. The index includes a response time showing the protocol processing time, and a bandwidth showing the maximum speed of data transfer to the unit.

Unit numbers 1602, 1603 and 1604 store performance values with respect to the backup unit represented by each unit number. “Unit number 1” of unit number 1602 corresponds to the first backup unit, “unit number 2” of unit number 1603 corresponds to the second backup unit, and “unit number 3” of unit number 1604 corresponds to the third backup unit.

FIG. 17 shows an example of a unit selection condition setup screen 1700. An example is illustrated in which the administrator uses the management computer 110 to perform setup so as to select a unit having a short response time when the transfer size is equal to or smaller than 1 MB.

FIG. 18 is a process flow of a backup module 603.

The backup module 603 is executed by the CPU 210 when a backup request is received from the backup response reception module 601. The backup request includes the information on the file system 251 to be subjected to backup. The information on the file system 251 can be, for example, a file system path such as “/mnt/filesystem/”.

When a backup request is received, the backup module 603 uses the object allocation management table 1500 to determine the file or the directory to be subjected to backup (S1801).

In the present step (S1801), the backup module 603 executes the following processes (18a) through (18e).

(18a) An object allocation reference request is issued to the object allocation management module 904, and the object allocation management table 1500 is acquired.

(18b) The file system 251 is scanned.

(18c) Whether a file ID 1502 is stored or not with respect to the path 1501 of each file or each directory detected through scanning is determined.

(18d) When a path 1501 not storing the file ID 1502 is found, it is determined that a file or a directory shown by the path 1501 is not subjected to backup, and the path 1501 is recorded in the backup target list.

(18e) When the scanning of all file systems 251 have been completed, the backup module 603 proceeds to S1802.

Next, the backup module 603 determines a file ID to be associated with a file or a directory (S1802).

In the present step (S1802), the backup module 603 executes the following processes of (18f) to (18h).

(18f) A file ID to be associated with a single path 1501 extracted from the backup target list is generated.

(18g) The object allocation update request is transmitted to the object allocation management module 904, which is stored in the file ID 1502 of the object allocation management table 1500.

(18h) When a response to the object allocation update request is received from the object allocation management module 904, the procedure advances to S1803. At this time, the file ID 1502 is the randomly generated UUID.

Next, the backup module 603 issues a unit selection request with respect to the backup unit selection program 800 (S1803).

In this step (S1803), the backup module 603 executes the following processes (18i) and (18j).

(18i) A path of a file is included in the unit selection request, and the request is transmitted to the backup unit selection program 800.

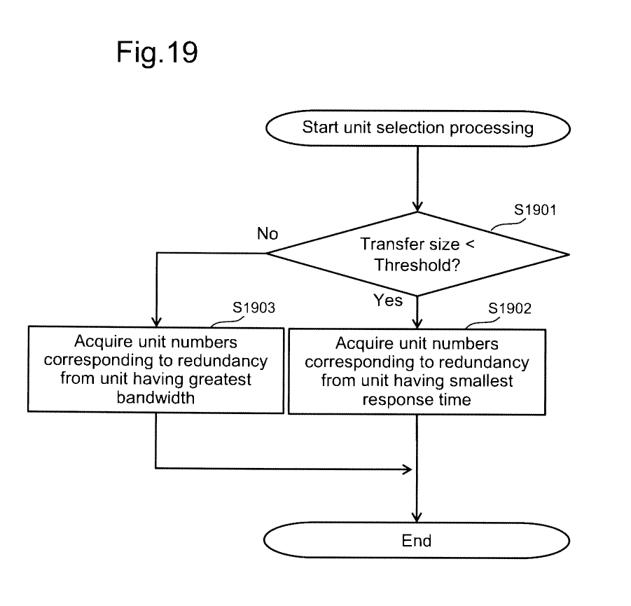

(18j) After a unit selection process (FIG. 19) is performed by the backup unit selection program 800, the procedure having acquired a unit selection response including the unit number(s) of the selected one or more backup units advances to S1804. The details of the unit selection process will be described later with reference to FIG. 19.

Next, the backup module 603 stores a file or a directory in the selected unit (S1804).

In the present step (S1804), the backup module 603 executes the processes of the following steps (18k) and (18l).

(18k) An object storage request is issued to the backup unit indicated by the unit number included in the unit selection response.

(18l) A response to the object storage request is received, and the procedure advances to S1805.

Next, the backup module 603 updates the object allocation (S1805).

In the present step (S1805), the backup module 603 executes the following steps (18m) and (18n).

(18m) An object allocation update request is transmitted to the object allocation management module 904, and a checkmark is entered to the portion of the object allocation management table 1500 corresponding to the unit number to which backup has been executed.

(18n) When a response to the object allocation update request is received from the object allocation management module 904, the procedure advances to S1806.

Next, the backup module 603 examines whether backup of all files or directories stored in the file system 251 has been completed or not (S1806).

In this step (S1806), the backup module 603 executes the following processes (18o) to (18q).

(18o) The path subjected to backup is deleted from the backup target list, and whether other paths are recorded is checked.

(18p) If there is no other recorded path, it is determined that backup has been completed (Yes).

(18q) If another path is recorded, the backup module 603 determines that backup is not completed (No), and returns to S1802.

Next, if S1806 is Yes, the backup module 603 transmits the object allocation management table 1500 to all backup units (S1807).

Finally, the backup module 603 transmits whether backup has been completed or not as the processing result to the backup response transmission module 602, and ends the backup processing.

Further, the backup processing can be performed via parallel processing from multiple processes or threads. In that case, the respective files or respective directories may be backed up in different units. Since the backup processing executed by the first process causes deterioration of the performance of the backup unit currently performing backup, a different backup unit with higher performance may be selected during selection of the backup unit for executing the second process.

FIG. 19 is a process flow of the unit selection module 804 during acquisition of backup.

The unit selection module 804 is executed via the CPU 210 when a unit selection request is received from the backup module 603. The unit selection request includes a transfer size which refers to the size of the requested data. In other words, the transfer size is either the metadata size of the directory or the file, or a portion or all of the file data.

The unit selection module 804 determines whether the transfer size is smaller than the threshold or not (S1901). That is, the unit selection module 804 acquires a threshold of the transfer size from the unit selection condition setup table 1300, compares the transfer size with the threshold, wherein if the transfer size is smaller, the procedure advances to S1902, and if not, the procedure advances to S1903.

If the transfer size is smaller than the threshold, the unit selection module 804 acquires a unit number corresponding to the redundancy from the unit number having the smallest response time (S1902). That is, the unit selection module 804 transmits a performance reference request to the performance measurement module 905 to acquire the performance measurement table 1600, and transmits a redundancy reference request to the redundancy setup module 906 to acquire the set redundancy, and based thereon, searches an entry of response time from viewpoint 160 to search for a minimum value of the values stored in unit numbers 1602, 1603 and 1604 to acquire the unit number including the unit number corresponding to the redundancy. Lastly, the unit selection module 804 transmits a response to the unit selection request notifying the unit number including the number corresponding to the redundancy to the request source. The unit number corresponding to the redundancy included in the response is not limited to a single number corresponding to the minimum value, but can be multiple (such as two) smallest numbers.

If the transfer size is equal to or greater than the threshold, the unit selection module 804 acquires a unit number corresponding to the redundancy starting from the unit number having the greatest bandwidth (S1903). In other words, the unit selection module 804 transmits a performance reference request to the performance measurement module 905 to acquire a performance measurement table 1600, and transmits a redundancy reference request to the redundancy setup module 906 to acquire the set redundancy, and based thereon, searches the entry of the bandwidth from viewpoint 1601 to find the maximum value of the values stored in unit numbers 1602, 1603 and 1604, and acquires the unit number including the number corresponding to the redundancy. Lastly, the unit selection module 804 transmits a response to the unit selection request notifying the unit number including the number corresponding to the redundancy to the request source. The unit number corresponding to the redundancy included in the response is not limited to a single maximum value, but can be multiple (such as two) greatest numbers.

FIG. 20 shows the flow of processing of a restore module 703.

A restore processing is performed for example when a storage system 200 is lost due to failure or the like. Therefore, it is necessary to have an alternative system of the storage system 200 prepared prior to starting the restore processing. At first, an operator (such as an administrator) prepares an alternative system of the storage system 200, and connects the same to a network 120. Thereafter, the operator transmits a configuration update request to the configuration definition module 903 using the management computer 110, and creates a configuration definition table 1400. Lastly, the operator uses the management computer 110 to transmit an object allocation recovery request to the object allocation management module 904, and acquires an object allocation management table 1500 from one of the backup units.

A restore module 703 is executed by the CPU 210 when a restore request is received from the restore request reception module 701. The restore request includes a path of a file or a directory to be restored and a file operation request.

At first, the restore module 703 determines whether the requested data has been restored or not (S2001). Here, requested data refers to the data required for the file operation program 500 to execute the file operation request, which is one of the following: the metadata of the directory, the metadata of the file, or the file data.

In the present step (S2001), the restore module 703 executes the following processes (20a) to (20d).

(20a) Transmit a restore progress reference request to the restore progress management module 704, and acquire a restore progress management table 1200.

(20b) Search an entry storing a path 1201 of the file or the directory to be restored from the restore progress management table 1200, and confirm whether a checkmark is entered in the corresponding metadata 1203 and 1204.

(20c) Only when a checkmark is entered in both the metadata 1203 and the data 1204, the module determines that the file or the directory is already restored in the file system 251 (Yes), and the restore processing is completed.

(20d) If not, the module determines that the file or the directory to be restored is not restored in the file system 251 (No), and the procedure advances to S2002.

Thereafter, the restore module 703 acquires the unit number of all units having a file or a directory shown by the path included in the restore request (S2002).

In this step (S2002), the restore module 703 executes the following processes (20e) and (20f).

(20e) An object allocation reference request is transmitted to the object allocation management module 904, and an object allocation management table 1500 is acquired.

(20f) An entry storing the file or the directory to be restored 1501 is searched from the object allocation management table 1500, and a unit number having a checkmark entered thereto is acquired.

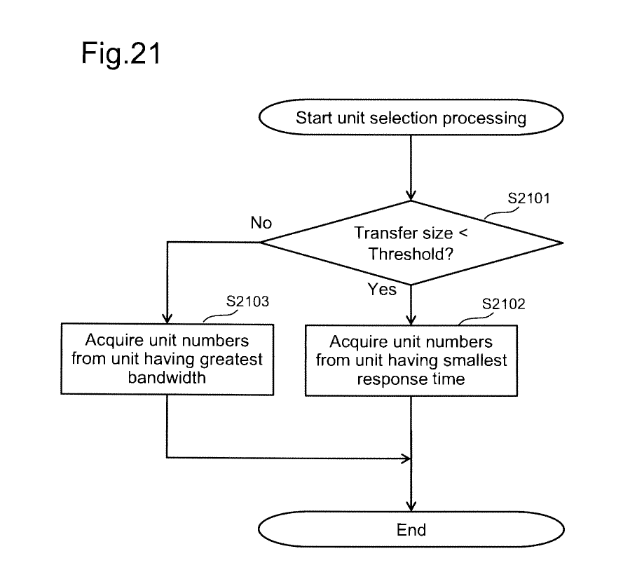

Next, the restore module 703 issues a unit selection request to the backup unit selection program 800 (S2003). When the unit selection processing has been performed by the backup unit selection program 800, the restore module 703 acquires a unit selection response including the unit number of the selected single backup unit, and proceeds to S2004. The details of the unit selection processing will be illustrated later with reference to FIG. 21.

Next, the restore module 703 restores the appropriate requested data from the selected unit based on whether the restore target is a file or a directory, and based on the content of the file operation request (S2004).

In the present step (S2004), the restore module 703 executes the processes of (20g) to (20l).

(20g) Whether the restore target is a file or a directory is checked. If the restore target is a file, the content of the file operation request is searched.

(20h) If the file operation request is a file create request or a directory create request, the restore processing will not be performed.

(20i) If the file operation request is a metadata read request or a metadata write request, the metadata of the file is set as the requested data.

(20j) If the file operation request is a data read request or a data write request, the metadata of the file and the file data are set as the requested data.

(20k) If the restore target is a directory, the metadata is set as the requested data. When the requested data is determined, an object acquisition request including the UUID of the requested data is transmitted to the selected backup unit.

(20l) When a response is received from the backup unit, the data included in the response is used to have the file or the directory restored in the file system 251, and thereafter, the procedure advances to S2005.

Next, the restore module 703 updates the restore progress (S2005).

In this step (S2005), the restore module 703 executes the following steps (20m) and (20n).

(20m) A restore progress update request is transmitted to the restore progress management module 704, and a checkmark is entered to the metadata 1203 or the data 1204 of the restored file or directory of the restore progress management table 1200.

(20n) When a response with respect to the restore progress management request is received from the restore progress management module 704, the restore process is completed.

FIG. 21 is a flow of processing of the unit selection module 804 during the restore processing.

The unit selection module 804 is executed by the CPU 210 when a unit selection request is received from the restore module 703. The unit selection request includes a transfer size which refers to the size of the requested data. In other words, the transfer size is either the metadata size of the directory or the file, or a portion or all of the file data.

The unit selection module 804 determines whether the transfer size is smaller than a threshold or not (S2101). In other words, the unit selection module 804 acquires the threshold of the transfer size from the unit selection condition setup table 1300, compares the transfer size with the threshold, wherein if the transfer size is smaller (Yes), the procedure advances to S2102, and if not (No), the procedure advances to S2103.

If the transfer size is smaller than the threshold, the unit selection module 804 acquires the unit number from the unit number having the smallest response time (S2102). That is, the unit selection module 804 transmits a performance reference request to the performance measurement module 905 to acquire the performance measurement table 1600, checks an entry of the response time from the viewpoint 1601, searches for the minimum value from the values stored in unit numbers 1602, 1603 and 1604, and acquires that unit number. Lastly, the unit selection module 804 transmits a response to the unit selection request including the unit number to the request source. The unit number included in the response can be a single number corresponding to the minimum value, or multiple numbers (such as two) from the smallest values.

When the transfer size is equal to or greater than the threshold, the unit selection module 804 acquires the unit number of the unit having the greatest bandwidth (S2103). In other words, the unit selection module 804 transmits a performance reference request to the performance measurement module 905 to acquire a performance measurement table 1600, checks the entries of the bandwidth from viewpoint 1601, and searches the maximum value out of the values stored in unit numbers 1602, 1603 and 1604 to acquire the unit number. Lastly, the unit selection module 804 transmits a response to the unit selection request including the unit number to the request source. Further, the unit number included in the response can be a single number corresponding to the maximum value, or multiple numbers (such as two) from the greatest values.

Embodiment 1 has been illustrated above.

According to embodiment 1, it becomes possible to select the communication destination backup unit based on a plurality of performance indexes including the response time and bandwidth, so that both the selection of a unit corresponding to a small-sized data and the selection of a unit corresponding to a large-sized data can be realized, and the time required for performing backup and restoration can be reduced. In addition to the plurality of performance indexes including the response time and bandwidth, the physical distance between the backup units and/or between the storage system and the backup unit can be added to the performance index from the viewpoint of reducing the risks related to data storage. In that case, the physical distance can be included in the viewpoint 1601 of the performance measurement table.

According further to embodiment 1, performance measurement is performed by transmitting and receiving test data with the respective backup units when the performance measurement module 905 receives a performance update request, but according to another example, it is possible to execute the performance measurement in the background and to update the performance measurement table when the performance update request is received. Now, if the performance measurement table is executed on the background, performance can be measured by actually executing backup or restoration of data instead of transmitting and receiving test data. In that case, during the initial backup or restoration, performance measurement is performed using test data, and thereafter, backup or restoration is performed to each backup unit to execute performance measurement. The reason for such operation is that performance measurement is not performed when backup or restoration has just started, and if each backup unit is not subjected to performance measurement sequentially, there may be a backup unit not subjected to performance measurement. Of course, it is possible to perform both sequential selection of backup units for performance measurement and selection of a backup unit expected to shorten the backup or restoration time. According to such configuration, if a batch restore program is activated for restoring all files or directories within the file system on the background while activating an on-demand restore program for performing restoration according to user access, the batch restore program executes performance measurement, updates the performance measurement table, and utilizes the result of the performance measurement to unit selection during on-demand restore operation or batch restore operation.

According to embodiment 1, the backup unit utilizes an object storage, but it can also utilize a file system similar to the storage system. Appropriate operation of embodiment 1 can be realized by replacing the file ID with a path, the object server program with a file server program, and the object operation program with a file operation program. In addition, the setting of backup redundancy can be performed for each file.

### Embodiment 2

Embodiment 2 will now be described. The differences with embodiment 1 will mainly be described, and the common sections with embodiment 1 will not be described.

According to embodiment 2, regarding the unit selection processing performed when executing backup or restoration through the method described in embodiment 1, an estimated transfer time of the file of each unit is computed from a plurality of performance indexes, and the unit having the shortest time is selected.

Now, embodiment 2 will be described in detail.

Simply put, according to embodiment 2, the unit selection module 804 constituting a portion of the backup unit selection program 800 differs from the configuration of embodiment 1.

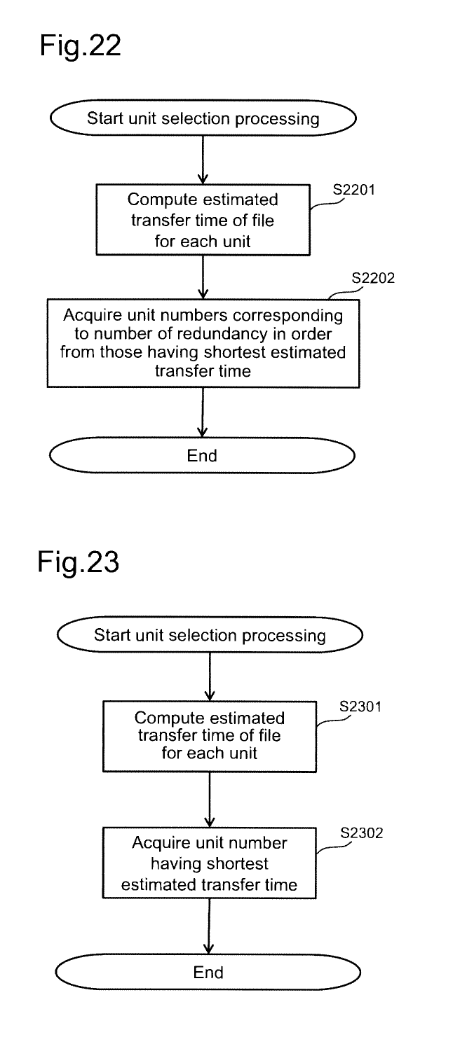

FIG. 22 is a flow of processing of the unit selection module 804 during acquisition of backup according to embodiment 2.

The unit selection module 804 is executed by the CPU 210 when a unit selection request is received from the backup module 603.

The unit selection module 804 computes the estimated transfer time of files for each backup unit (S2201). At first, the unit selection module 804 transmits a performance reference request to the performance measurement module 905 to acquire a performance measurement table 1600 and transmits a redundancy reference request to the redundancy setup module 906 to acquire the set redundancy. Thereafter, the unit selection module 804 computes the estimated transfer time (1/1000+s/b) sec of a case where the data is sent to a certain backup unit using a transfer size s [MB] included in the unit selection request and the response time 1 [msec] and bandwidth b [MB/s] of the certain backup unit included in the acquired performance measurement table 1600. When the estimated transfer time of all the backup units has been computed, the procedure advances to S2202.

The unit selection module 804 acquires the unit numbers corresponding to the number of redundancy sequentially in order from the unit number having the smallest estimated transfer time (S2202). The unit selection module 804 searches for the smallest values of estimated transfer time with respect to each backup unit having been computed, and acquires the unit numbers corresponding to the redundancy sequentially in order from the smallest value. Lastly, the unit selection module 804 transmits a response to the unit selection request including the unit number(s) to the request source.

FIG. 23 is a flow of processing of the unit selection module 804 when a restore processing is performed according to embodiment 2.

The unit selection module 804 is executed via the CPU 210 when a unit selection request is received from the restore module 703.

The unit selection module 804 computes an estimated transfer time of a file for each backup unit (S2301). At first, the unit selection module 804 transmits a performance reference request to the performance measurement module 905, and acquires a performance measurement table 1600. Thereafter, the unit selection module 804 computes the estimated transfer time (1/1000+s/b) sec for sending data to a certain backup unit using the transfer size s [MB] included in the unit selection request and the response time 1 [msec] and bandwidth b [MB/s] of the certain backup unit included in the acquired performance measurement table 1600. When the estimated transfer time of all backup units have been computed, the procedure advances to S2302.

The unit selection module 804 acquires the unit number having the smallest estimated transfer time (S2302). The unit selection module 804 searches the minimum value from the computed estimated transfer time of each backup unit, and acquires the unit number thereof. Lastly, the unit selection module 804 transmits a response to the unit selection request including the unit number to the request source.

Embodiment 2 has been described above.

According to embodiment 2, it becomes possible to select a backup unit for performing data communication from a value computed based on multiple performance indexes including the response time and bandwidth, so that both the selection of a unit corresponding to a small-sized data and the selection of a unit corresponding to a large-sized data can be realized, and the time required for performing backup and restoration can be reduced.

### Embodiment 3

Embodiment 3 will now be described. The differences with embodiment 1 will mainly be described, and the common sections with embodiment 1 will be omitted. According to embodiment 3, the storage system processes a plurality of backup requests or a plurality of restore requests. The storage system selects a plurality of units when performing backup or restoration, and appropriately distributes the backup requests or the restore requests to the selected plurality of units.

Now, embodiment 3 will be described in detail.

Simply put, according to embodiment 3, the backup module 603 constituting a portion of the backup program 600, the restore module 703 constituting a portion of the on-demand restore program 700, the unit selection module 804 constituting a portion of the backup unit selection program 800, the performance measurement module 905 constituting a portion of the backup unit management program 900 and the performance measurement table 1600 differ from the configuration of embodiment 1.

When a performance update request is received, the performance measurement module 905 measures, in addition to the response time and the bandwidth which are the two performance indexes according to embodiment 1, a backup processing performance indicating the number of backup operations that can be processed per unit time, and a restore processing performance indicating the number of restore operations that can be processed per unit time. At first, the performance measurement module 905 transmits a plurality of files (such as 100 files) having small sizes (such as 4 KB) as test data to a certain backup unit. When transmission to that backup unit is completed, the performance measurement module 905 sets the value having divided the number of transmitted data by the required time as the backup processing performance. Next, the performance measurement module 905 receives the plurality of small sized files being transmitted from the backup unit. When reception from the backup unit has been completed, the performance measurement module 905 sets the value having divided the number of received data by the required time as the restore processing performance. The performance measurement module 905 sequentially performs such measurement of the backup processing performance and the restore processing performance to all backup units, and finally, updates the performance measurement table 1600.

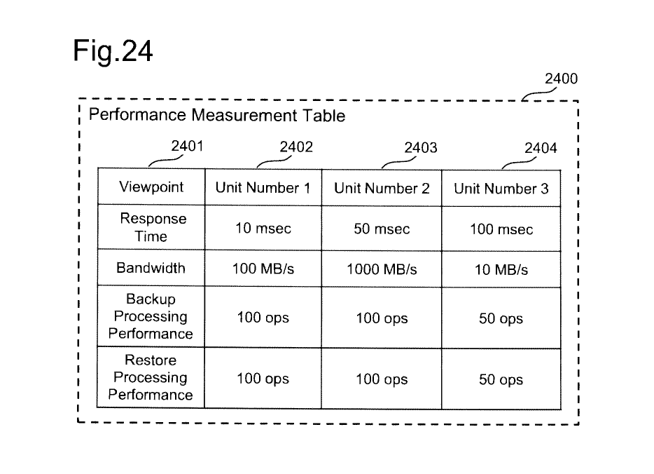

FIG. 24 is a view showing one example of a performance measurement table 2400.

The performance measurement table 2400 includes a viewpoint 2401 and unit numbers 2402, 2403 and 2404.

The viewpoint 2401 stores the name of the index in performance measurement. The index includes a response time indicating the protocol processing time, a bandwidth indicating the maximum rate of data transfer to the unit, a backup processing performance indicating the number of backup operations that can be processed per unit time, and a restore processing performance indicating the number of restore operations that can be processed per unit time.

Unit numbers 2402, 2403 and 2404 store performance values with respect to the backup units represented by each unit number.

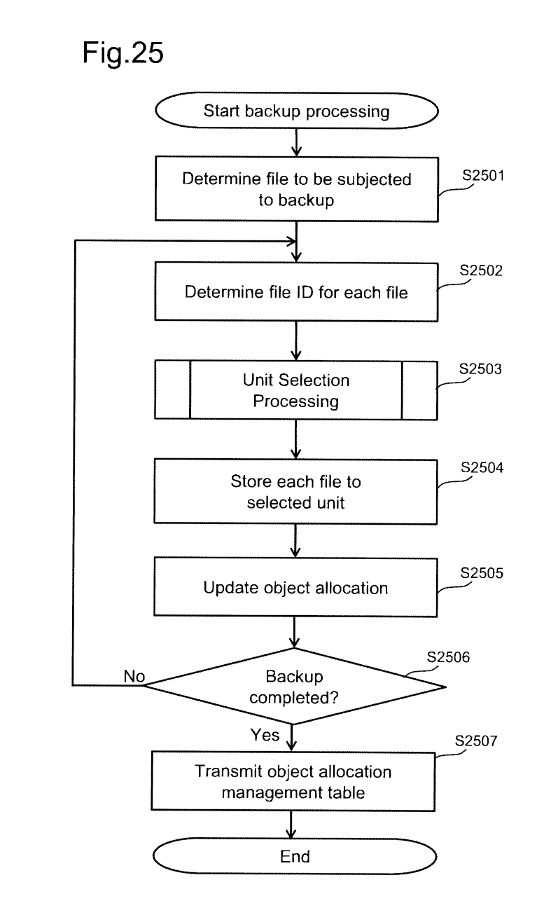

FIG. 25 is a flow of the processing of a backup module 603.

The backup module 603 is executed by the CPU 210 when a backup request is received from the backup response reception module 601. The backup request includes a path of the file system 251 to be subjected to backup.

When a backup request is received, the backup module 603 uses the object allocation management table 1500 to determine the file or the directory to be subjected to backup (S2501). The process performed in this step is equivalent to S1801. When the scanning of all the file systems 251 has been completed, the backup module 603 advances to S2502.

Next, the backup module 603 determines the file ID associated with each file or each directory (S2502).

In the present step (S2502), the backup module 603 executes the following processes (25a) through (25c).

(25a) A file ID associated with paths 1501 corresponding to a given unit (such as ten) exerted from the backup target list is created.

(25b) An object allocation update request is transmitted to the object allocation management module 904, which is stored in the file ID 1502 of the object allocation management table 1500.

(25c) When a response corresponding to the object allocation update request is received, the object allocation management module 904 advances to S2503.

Next, the backup module 603 issues a unit selection request with respect to the backup unit selection program 800 (S2503).

In the present step (S2503), the backup module 603 executes the following processes (25d) and (25e).

(25d) The unit selection request including paths of a given unit of (such as ten) files or directories is transmitted to the backup unit selection program 800.

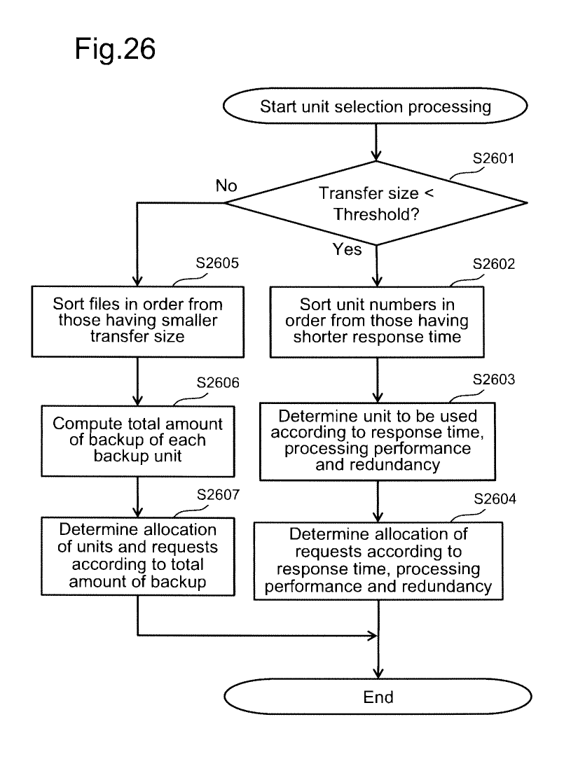

(25e) After the unit selection processing has been performed by the backup unit selection program 800, when a unit selection response including a plurality of unit numbers of units for performing backup of respective files or respective directories is obtained, the procedure advances to S2504. The details of the unit selection processing will be described later with reference to FIG. 26.

Next, the backup module 603 stores files or directories in the selected unit (S2504).

In this step (S2504), the backup module 603 executes the following processes (25f) and (25g).

(25f) An object storage request of a plurality of files or directories is issued to a backup unit shown by the unit number included in the unit selection response.

(25g) A response to the object storage request is received, and the procedure advances to S2505.

Next, the backup module 603 updates the object allocation (S2505). This step is similar to S1805. When the backup module 603 receives a response to the object allocation update request from the object allocation management module 904, the procedure advances to S2506.

Next, the backup module 603 examines whether the backup of all the files or directories stored in the file system 251 have been completed or not (S2506). This step is similar to S1806. If the backup has been completed (Yes), the backup module 603 transmits an object allocation management table 1500 to all backup units (S2507).

Finally, the backup module 603 transmits whether the backup has been completed or not as the processing result to the backup response transmission module 602, and ends the backup processing.

In S2506, if a different path is entered, the backup module 603 determines that backup has not been completed (No), and the procedure returns to S2502.

FIG. 26 is a flow of processing of the unit selection module 804 during acquisition of backup.

The unit selection module 804 is executed by the CPU 210 when a unit selection request is received from the backup module 603. The unit selection request includes paths of a given unit of (such as ten) files or directories, and a transfer size indicating the size of each requested data. In other words, the transfer size is the metadata size of a directory or a file, or a portion or all of the file data.

The unit selection module 804 determines whether the transfer size is smaller than a threshold or not (S2601). That is, the unit selection module 804 acquires a threshold of the transfer size from the unit selection condition setup table 1300, compares the transfer size with the threshold, wherein if the transfer size is smaller (Yes), the procedure advances to S2602, and if not (No), the procedure advances to S2605.

If the transfer size is smaller than the threshold (Yes), the unit selection module 804 rearranges the unit numbers in ascending order from those having shorter response times (S2602).

In the present step (S2602), the unit selection module 804 executes the following processes (26a) and (26b).

(26a) A performance reference request is transmitted to the performance measurement module 905, and a performance measurement table 2400 is acquired.

(26b) Entries of response time are searched from the viewpoint 2401, and the unit numbers 2402, 2403 and 2404 are rearranged in order from those having smaller response time. Hereafter, the values rearranged and stored in the performance measurement table 2400 are referred to as l(1), l(2) and l(3), and the backup processing performances are referred to as p(1), p(2) and p(3).

Next, the unit selection module 804 determines the unit to be used according to the response time, the backup processing performance and the redundancy (S2603). Here, the number of the transfer size smaller than the threshold is m (wherein m is a natural number satisfying 0<m<10 or 0<m=10), the redundancy is r (wherein r is a natural number satisfying 0<r<n or 0<r=n), and the total number of request processes of all backup units that can be processed within a response time of the i-th backup unit (wherein i is a natural number satisfying 0<i<n or 0<i=n) is S(i)=l(i)×{p(1)+p(2)+ . . . +p(i)}/1000. The unit selection module 804 calculates i that satisfies S(i−1)<m×r<S(i) or S(i−1)<m×r=S(i) and i>r or i=r with respect to the given m and r, and determines that backup units up to the i-th backup unit are to be used. Incidentally, S(0)=0. For example, when m=4 and r=2, S(1)=l(1)×p(1)/1000=10×100/1000=1, S(2)=l(2)×{p(1)+p(2)/1000=50×(100+100)/1000=10, so that i=2 is obtained, and the obtained value is r=2 or greater. At this time, the unit selection module 804 will use the first backup unit and the second backup unit, and will not use the third backup unit. Further according to the above calculation, if the i satisfying S(i−1)<m×r<S(i) or S(i−1)<m×r=S(i) is i<r, a result of i=r is obtained.

Next, the unit selection module 804 determines the distribution of the number of requests according to the response time, the backup processing performance and the redundancy (S2604). The distribution of the number of requests is determined by allocating the units to be used sequentially in order from those having shorter response times so that the distribution corresponds to the ratio of processing performances at maximum and that the same data is prevented from being stored in the same backup unit. For example, when m=4 and r=2 in the backup processing, four requests are distributed respectively to the first backup unit and the second backup unit. Therefore, the unit selection module 804 performs the following processes of (26c) to (26g).

(26c) The ratio of backup processing performances of the first backup unit and the second backup unit is computed based on the performance measurement table 2400, and a result of 1:1 is obtained.

(26d) Since requests of 10 or smaller is to be processed as shown by S(2)=10, it is determined that the maximum value is 5:5.

(26e) Based on r=2, since the data stored in the first backup unit will also be stored in the second backup unit, it is determined that there are four requests each.

(26f) The four requests are allocated to the first backup unit having a short response time, and the remaining four requests are allocated to the second backup unit having the second shortest response time.

(26g) After allocation is determined, the response to the unit selection request including the information associating a path having a smaller transfer size than the threshold with the unit number based on the determined allocation is transmitted to the request source.

Now, if the number of backup units i is greater than the redundancy r, the redundant data is stored in the backup unit having the shortest response time and the backup unit having the second shortest response time.

If the transfer size is equal to or greater than the threshold (No), the unit selection module 804 sorts the files in order from those having a smaller transfer size (S2605). The unit selection module 804 rearranges the file paths in ascending order from those having smaller transfer sizes included in the unit selection request, and then the procedure advances to S2606.

Next, the unit selection module 804 computes the total amount of backup of each backup unit (S2606). Here, the total amount of backup T of the backup unit refers to the sum of the transfer size to be transferred to the backup unit. The total amount of backup of a certain backup unit is calculated by the product of the sum of the transfer size of all files, the ratio of bandwidth of a certain backup unit with respect to the bandwidth of the backup units, and the redundancy set up in the storage system 200. As an example, the total amount of backup T(1) of the first backup unit in a case where the storage system 200 set to redundancy 2 performs backup of ten 1-GB-files to the backup unit having a bandwidth shown in the performance measurement table 1600 will be calculated. The sum of the transfer size of all files is 1×10=10 (GB) and the ratio of bandwidth of the first backup unit is 100/(100+1000+10)=0.090, so that T(1)=10×(1090×2=1.8 (GB) is calculated. Similarly, T(2)=2×10×1000/(100+1000+10)=18 (GB) and T(3)=2×10×10/(100+1000+10)=0.18 (GB) are calculated. In the example, the significant figures of calculation are double digits, wherein triple and smaller digits are cutoff.

Next, the unit selection module 804 determines the allocation of backup units and requests according to the total amount of backup (S2607).

According to this step (S2607), the unit selection module 804 executes the following processes (26h) to (261).

(26h) A single file path is acquired based on the order of file paths rearranged in S2605.

(26i) A number of backup units having a total amount of backup that is the same as or greater than the file size are selected corresponding to the number of redundancy sequentially from the unit having the smallest total amount of backup, and the backup units are set as backup destinations of the file shown by the file path. At this time, the backup unit having a total amount of backup that is smaller than the transfer size is excluded from the candidate of backup destination of the file in the following processes.

(26j) The difference between the total amount of backup of the backup unit selected as the backup destination and the transfer data quantity of the file to be subjected to backup is computed, and the result is set as the new total amount of backup of that backup unit.

(26k) The next single file path is acquired according to the order of file paths rearranged in S2605, and the backup units of all file paths are determined in a similar method as the method described above. However, if there is no backup unit having a total amount of backup greater than the file size, the number of backup units that is the same as the remaining number of redundancy is set as the backup destination.

(26l) A response to the unit selection request including the unit number selected in association with the file path is transmitted to the request source. For example, the following operation is performed when a storage system 200 being set to redundancy 2 performs backup of ten 1-GB-files to backup units having a bandwidth shown in the performance measurement table 1600. At first, a first file (size 1 GB) is acquired, and thereafter, based on the total amount of backup T(1)=1.8, T(2)=18 and T(3)=0.18 of the respective backup units, the first backup unit and the second backup unit which are backup units having a size equal to or greater than 1 GB are selected as candidates. Next, from the two candidates, the same number of backup units as redundancy 2 are selected in order from the one having the smallest total amount of backup, according to which the first backup unit and the second backup unit are set as backup destination. Next, the new total amount of backup is set to T(1)=1.8−1=0.8, T(2)=18−=17, and T(3)=0.18. The unit selection module 804 performs such processing to all file paths included in the unit selection request, according to which the unit numbers selected for each file path can be acquired.

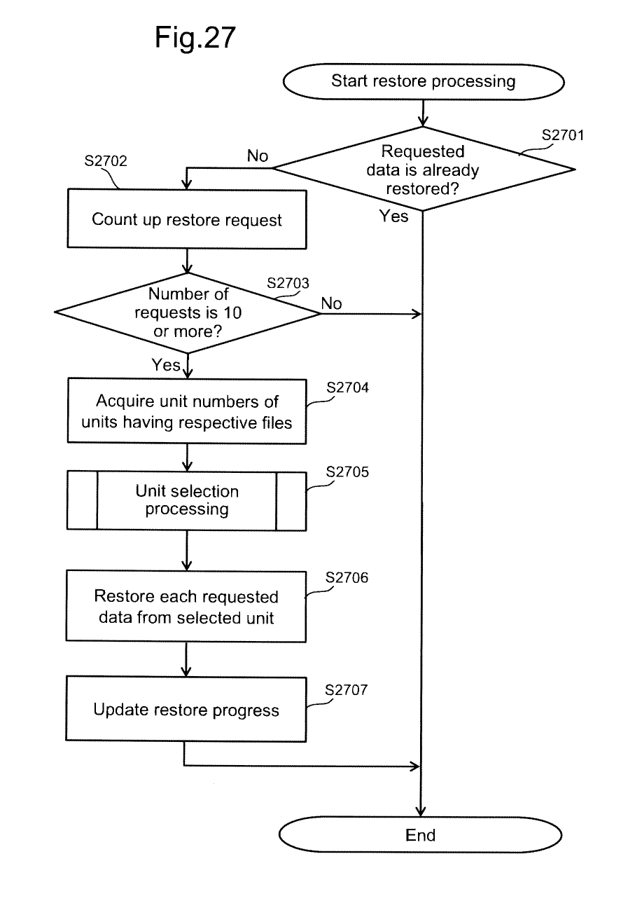

FIG. 27 is a flow of processing of a restore module 703.

The restore module 703 is executed by the CPU 210 when a restore request is received from the restore request reception module 701. The restore request includes a path of a file or a directory to be restored, and a file operation request.

At first, the restore module 703 determines whether the requested data has been restored or not (S2701). This step is the same as S1901. If the data has been restored to the file system 251 (Yes), the restore module 703 completes the restore processing. If not (No), the procedure advances to S2702.

Next, the restore module 703 buffers the received restore request to the memory 260, increments the buffered restore request (+1) (S2702), and thereafter, confirms whether the counted value, that is, the number of requests, is greater than a given unit, such as 10 (S2703). If there are 10 or more requests (Yes), the procedure advances to S2704. In other cases (No), the restore processing is completed without responding to the restore request. Of course, even if the number of requests is smaller than 10, the procedure can be advanced to S2704 if a given time has elapsed.

Next, the restore module 703 acquires units numbers of multiple units having files or directories corresponding to a given unit, such as 10 (S2704).

In the present step (S2704), the restore module 703 executes the following processes (27a) and (27b).

(27a) An object allocation reference request is transmitted to the object allocation management module 904, and an object allocation management table 1500 is acquired.

(27b) Entries storing all the files or directories 1501 to be restored are searched from the object allocation management table 1500, and the unit numbers having checkmarks entered thereto are acquired.

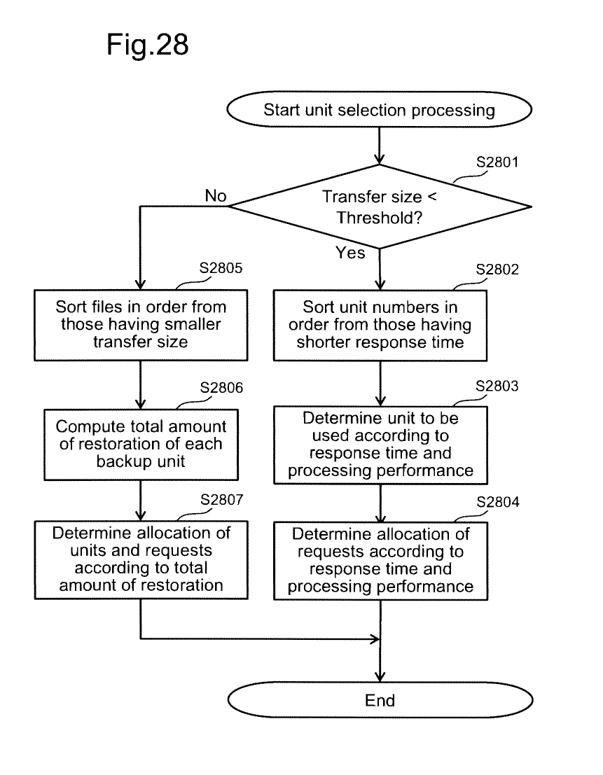

Next, the restore module 703 issues a unit selection request to the backup unit selection program 800 (S2705). After the unit selection processing has been performed by the backup unit selection program 800, the restore module 703 acquires a unit selection response including a unit number of the selected single backup unit, and the procedure advances to S2706. The details of the unit selection processing will be described later with reference to FIG. 28.

Next, the restore module 703 restores an appropriate requested data from the selected units based on whether the restore target is a file or a directory, or the content of the file operation request (S2706).

In this step (S2706), the restore module 703 executes the following processes (27c) to (27e).

(27c) Whether the restore target is a file or a directory is examined via a similar method as S2004, and all the requested data are determined.

(27d) An object acquisition request including the UUID of all requested data is transmitted to the selected backup unit.

(27e) When a response is received from the backup unit, all the files or directories are restored in the file system 251 using the data included in the response, and the procedure advances to S2707.

Next, the restore module 703 updates the restore progress (S27007). That is, the restore module 703 updates the restore progress management table 1200 via a similar method as S2005, and completes the restore processing.

FIG. 28 is a flow of processing of the unit selection module 804 in the restore processing.

The unit selection module 804 determines whether the transfer size is smaller than a threshold or not (S2801). The unit selection module 804 compares the transfer size and the threshold via a similar method as S2601, wherein if the transfer size is smaller (Yes), the procedure advances to S2802, and if not (No), the procedure advances to S2805.

If the transfer size is smaller than the threshold (Yes), the unit selection module 804 rearranges the unit numbers in ascending order from those having shorter response times (S2802). In other words, the unit selection module 804 rearranges the unit numbers of the backup units in order from those having shorter response times via a similar method as S2602. Hereafter, after rearrangement, the units are referred to, in the order from the unit having the smallest response time, l(1), l(2) and l(3), and the backup processing performance or the restore processing performance are referred to as p(1), p(2) and p(3).

Next, the unit selection module 804 determines the unit to be used according to the response time and the restore processing performance (S2803). Now, if it is assumed that the number having a transfer size smaller than the threshold is m (wherein m is a natural number satisfying 0<m<10 or 0<m=10), the sum of the number of processes of requests of all backup units that can be processed within the response time of the i-th backup unit (wherein i is a natural number satisfying 0<i<n or 0<i=n) can be expressed as S(i)=1(i)×{p(1)+p(2)+ . . . +p(i)}/1000. The unit selection module 804 calculates i that satisfies S(i−1)<m<S(i) or S(i−1)<m=S(i) with respect to the given m, and determines that backup units up to the i-th backup unit is to be used. Incidentally, S(0)=0. For example, when m=7, S(1)=l(1)×p(1)/1000=10×100/1000=1 and S(2)=l(2)×{p(1)+p(2)}/1000=50×(100+100)/1000=10, the unit selection module 804 calculates i=2. At this time, the unit selection module 804 decides to use the first backup unit and the second backup unit, and will not use the third backup unit.

Next, the unit selection module 804 determines the allocation of the number of requests according to the response time and the processing performance (S2804). The allocation of the number of requests is determined by allocating the units to be used sequentially in order from the unit having the shortest response time so that the allocation is at maximum proportional to the processing performance. For example, when m=7, five requests and two requests are respectively allocated to the first backup unit and the second backup unit. The unit selection module 804 executes the following processes (28a) to (28d).

(28a) The ratio of backup processing performances of the first backup unit and the second backup unit is computed based on the performance measurement table 2400, and a result of 1:1 is obtained.

(28b) Since S(2)=10, it is determined that the ratio of performances should be, at maximum, 5:5.

(28c) The five requests are allocated to the first backup unit having the shortest response time, and the remaining two requests are allocated to the second backup unit having the second shortest response time.

(28d) After determining the allocation, a response to the unit selection request including the information having associated the unit number to a path having a threshold smaller than the transfer size based on the determined allocation is transmitted to the request source.

If the transfer size is equal to or greater than the threshold (No), the unit selection module 804 sorts files in ascending order from the file having the smallest transfer size (S2805). That is, the unit selection module 804 rearranges the file paths in ascending order from the file having the smallest transfer size included in the unit selection request, and then the procedure advances to S2806.

Next, the unit selection module 804 computes the total amount of restoration of each backup unit (S2806). At this time, the total amount of restoration T of the backup unit refers to the sum of the transfer size requested to the backup unit. The total amount of restoration of a certain backup unit is calculated from the product of the sum of the transfer size of all files and the ratio of bandwidth of the backup unit with respect to the bandwidth of the respective backup units. As an example, the storage system 200 calculates a total amount of backup T(1) of the first backup unit when 10 one-GB-files are restored from the backup unit having the bandwidth shown in the performance measurement table 1600. Since the sum of the transfer size of all files is 1×10=10 (GB) and the ratio of bandwidth of the first backup unit is 100/(100+1000+10)=0.090, the calculated value is T(1)=10×0.090=0.90 (GB). Similarly, T(2)=10×1000/(100+1000+10)=9.0 (GB) and T(3)=10×10/(100+1000+10)=0.090 (GB) are calculated. In the example, the significant figures of calculation are double digits, wherein triple and smaller digits are cutoff.

Next, the unit selection module 804 determines the allocation of the backup units and requests according to the total amount of restoration (S2807).

In this step (S2807), the unit selection module 804 executes the following processes (28e) to (28i).

(28e) A single file path is acquired in the order of file paths rearranged in S2805.

(28f) The backup unit having a total amount of restoration which is equal to or greater than the file size and the smallest restore capacity is set as the restore source of the file shown by the file path. At this time, the backup unit having a total amount of restoration which is smaller than the transfer size is excluded from the candidate of backup destination of the file in the following processes.

(28g) A difference between the total amount of restoration of the backup unit selected as backup destination and the amount of transfer data of the file to be subjected to backup is calculated, and the value is set as the new total amount of backup of that backup unit.

(28h) The next single file path is acquired from the order of file paths rearranged in S2805, and backup units are determined for all file paths in a similar method as the method mentioned above.

(28i) A response to the unit selection request including the unit number selected in association with the file path is transmitted to the request source. For example, the following process is performed to restore 10 one-GB-files from the backup unit having a bandwidth shown in the performance measurement table 1600. At first, the unit selection module 804 acquires the first file (having a size of 1 GB). Next, the unit selection module 804 determines, based on the total amount of restoration T(1)=0.90, T(2)=9.0 and T(3)=0.090 of each back unit, the second backup unit which is a backup unit having an equal or a greater amount of restoration than 1 GB and having the greatest total amount of restoration as the restore source. Next, new values are set as T(1)=0.90, T(2)=9.0−1=8.0 and T(3)=0.090. The unit selection module 804 performs such processing to all the file paths included in the unit selection request, according to which unit numbers selected for each file path can be obtained.

The above has illustrated embodiment 3.

According to embodiment 3, it becomes possible to reduce the time required for each restoration and to shorten the response time with respect to the burst-like small-sized on-demand restore processing that occurs when concentrated read requests and write requests occur to the metadata in the storage system.

In embodiment 3, the number 10 has been used as the number of requests for starting the process during backup and restore processing, but other numbers such as 5 or 20 can be used. Further, the number can be set for each unit according to the hardware configuration influencing parallel processing, such as the number of CPU cores.

### Embodiment 4

Next, embodiment 4 will be described. In the following description, the differences with embodiment 1 will mainly be described, and the common areas with embodiment 1 will not be described.

According to embodiment 4, when the backup unit performs version management of an object, the restore destination is selected based on multiple performance indexes, and the file system of a specific version is restored. Version management is a process for retaining the history data of all stored objects.

Now, embodiment 4 will be described in detail.

Simply put, according to embodiment 4, the object server program 1000, the object operation program 1100, the object operation program 1100, the backup module 603 constituting a portion of the backup program 600, the restore module 703 constituting a portion of the on-demand restore program 700, the object allocation management table 1500, and the restore progress management module 704 differ from the configuration of embodiment 1.

In addition to embodiment 1, the object server program 1000 serves version-managed objects. Similar to embodiment 1, the object server program 1000 includes an object request reception module 1001 and an object response transmission module 1002. The object operation request that the object request reception module 1001 receives includes a version ID in addition to the UUID described in embodiment 1. A version ID is a sequential number such as “1” and “2”. The object request reception module 1001 transmits the received object operation request to the object operation program 1100. The object response transmission module 1002 is the same as embodiment 1.

The object operation program 1100 is capable of performing operation of an object subjected to version management in addition to the example of embodiment 1. The object operation program 1100 includes, similar to embodiment 1, an object storage module 1101 and an object acquisition module 1102. The object storage module 1101 associates the contents included in the object storage request with the UUID included in the object storage request and the version ID, and stores the same in the object storage 341. The object acquisition module 1102 reads the object associated with the UUID included in the object acquisition request and the version ID from the object storage 341.

The backup program 600 performs backup by designating the version ID of the object in addition to the example of embodiment 1. The backup program 600 includes, similar to embodiment 1, a backup response reception module 601 and a backup response transmission module 602. The backup response reception module 601 transmits the received backup request having the version ID added thereto to the backup module 603. The backup response transmission module 602 and the backup module 603 are the same as embodiment 1.

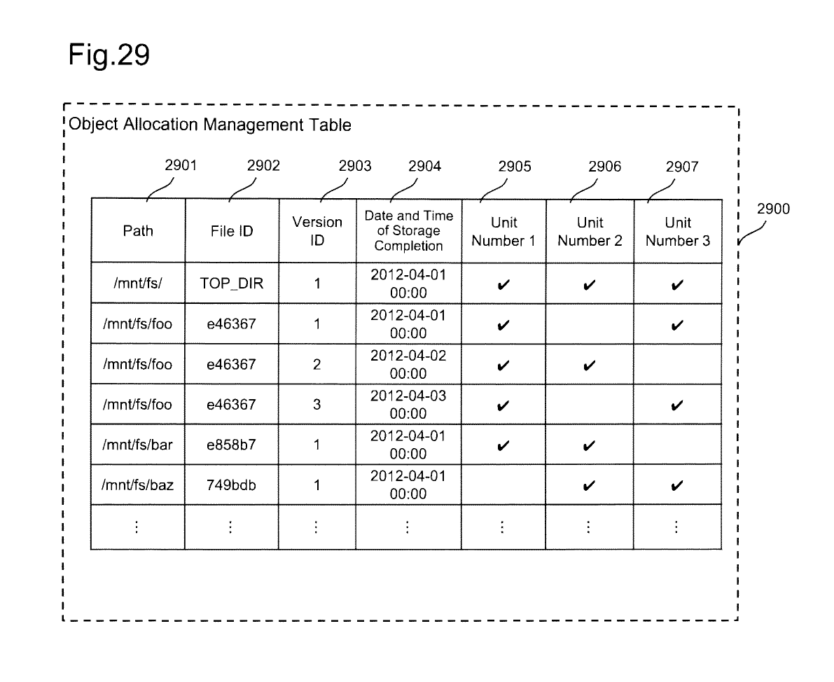

FIG. 29 is a view showing one example of an object allocation management table 2900.

The object allocation management table 2900 includes a path 2901, a file ID 2902, a version ID 2903, a storage complete date and time 2904, and unit numbers 2905, 2906 and 2907. The path 2901, the file ID 2902, and the unit numbers 2905, 2906 and 2907 are the same as embodiment 1. The version ID 2903 stores the unique version ID associated with the object. The storage complete date and time 2904 stores the date and time when the object is stored in the backup unit.

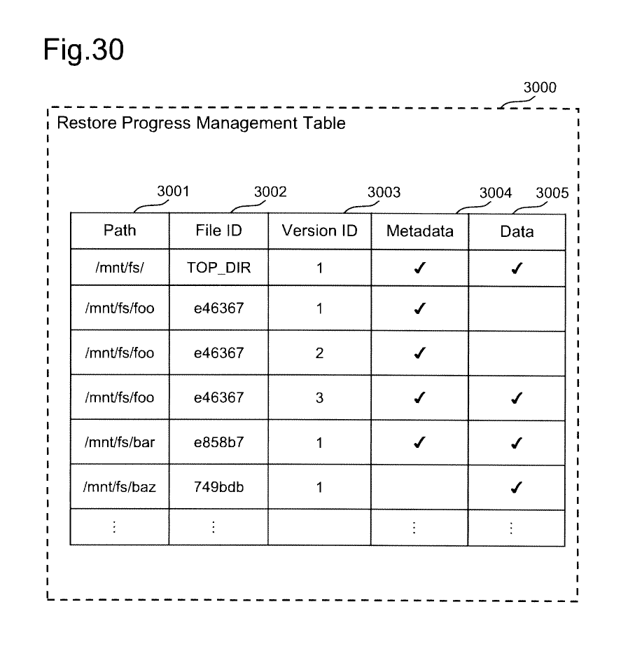

FIG. 30 is a view showing one example of a restore progress management table 3000.

The entries of the restore progress management table 3000 include a path 3001, a file ID 3002, a version ID 3003, a metadata 3004, and a data 3005. The path 3001, the file ID 3002, the metadata 3004 and the data 3005 are the same as embodiment 1. The version ID 3003 stores the unique version ID associated with the object. It is also possible to assign serial numbers as version IDs.

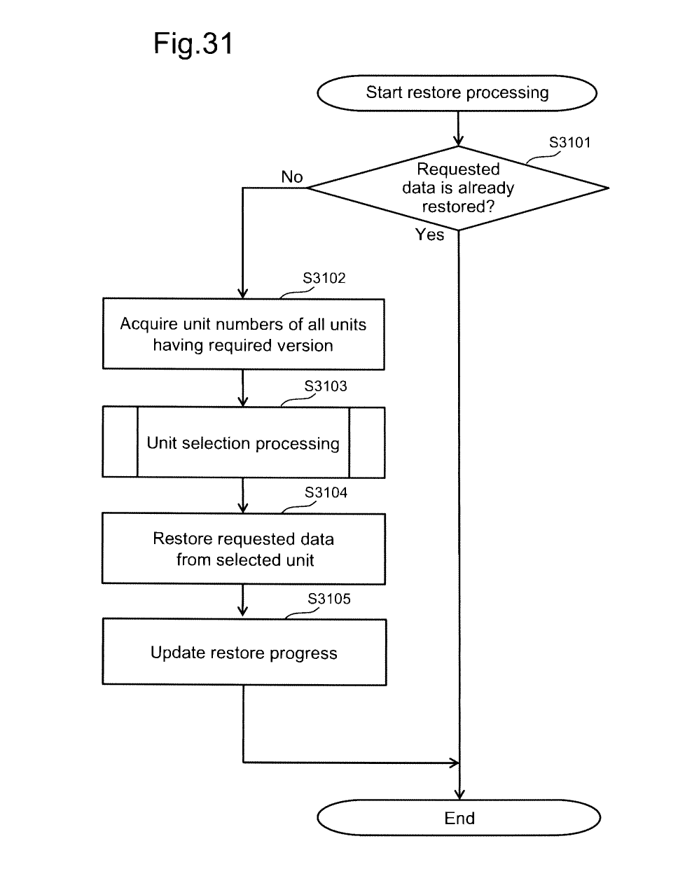

FIG. 31 is a flow of processing of the restore module 703.

The restore request received by the restore module 703 includes a path of a file or a directory to be restored, a time (restore target time) at which the file or directory to be restored has existed in the storage system 200, and a file operation request.

At first, the restore module 703 determines whether the requested data has been restored or not (S3101).

In this step (S3101), the restore module 703 executes the following processes (31a) to (31f).

(31a) An object allocation reference request is transmitted to the object allocation management module 904, and an object allocation management table 2900 is acquired.

(31b) An entry corresponding to the path of the file or the directory to be restored and having a storage complete time that is newer than the restore target time and closest to the current time is searched from the object allocation management table 2900, and the version ID thereof is acquired.

(31c) A restore progress reference request is transmitted to the restore progress management module 704, and a restore progress management table 3000 is acquired.

(31d) An entry in which both the path 3001 of the file or the directory to be restored and the version ID 3003 correspond is searched from the restore progress management table 3000, and whether a checkmark is entered to the corresponding metadata 3004 and data 3005 is confirmed.

(31e) Only if a checkmark is entered to both the metadata 3004 and the data 3005, it is determined that the file or directory is already restored in the file system 251 (Yes), and the restore processing is completed.

(31f) If not, it is determined that the file or the directory to be restored is not restored in the file system 251 (No), and the procedure advances to S3102.

Next, the restore module 703 acquires the unit numbers of all the units having a file or a directory corresponding to the acquired version ID (S3102). The restore module 703 searches an entry storing the file or the directory to be restored from the object allocation management table 2900, and acquires the unit number having a checkmark entered thereto.

Next, the restore module 703 issues a unit selection request to the backup unit selection program 800 (S3103). After unit selection processing is performed by the backup unit selection program 800, the restore module 703 acquires a unit selection response including the unit number of the selected single backup unit, and the procedure advances to S3104. The details of the unit selection processing is the same as FIG. 21 of embodiment 1.

Next, the restore module 703 restores an appropriate requested data from the selected unit based on whether the restore target is a file or a directory and the content of the file operation request (S3104). After the requested data is determined via the method illustrated in embodiment 1, the restore module 703 executes the following processes (31g) to (31j) in the present step (S3104).

(31g) An object acquisition request including the UUID and the version ID of the requested data is transmitted to the selected backup unit.

(31h) When a response is received from the backup unit, the file or the directory is restored in the file system 251 using the data included in the response, and the procedure advances to S3105.

Next, the restore module 703 updates the restore progress (S3105).

In the present step (S3105), the restore module 703 executes the following processes.

(31i) A restore progress update request is transmitted to the restore progress management module 704, and a checkmark is entered to the metadata 3004 and the data 3005 corresponding to the restored file or directory of the restore progress management table 3000.

(31j) When a response to the restore progress management request is received from the restore progress management module 704, the restore processing is completed.

The above has illustrated embodiment 4.

According to embodiment 4, when a backup unit having a version management function is used, it becomes possible to reduce the time required to restore the file or the directory that has existed in the storage system at an arbitrary time.

### Embodiment 5

Now, embodiment 5 of the present invention will be described. The differences with embodiment 1 are mainly described, and the common sections with embodiment 1 will not be described.

In embodiment 5, a relay storage system that differs from the storage system and the backup unit will be used. During restoration, the storage system restores data directly from the backup unit or indirectly via the relay storage system.

Now, embodiment 5 will be described in detail.

Simply put, according to embodiment 5, a relay storage system is added newly to the configuration of embodiment 1. In addition, the restore module 703 constituting a portion of the on-demand restore program 700, the configuration definition module 903 and the configuration definition table 1400 constituting a portion of the backup unit management program 900, and the performance measurement module 905 and the performance measurement table 1600 constituting a portion of the backup unit management program 900 differ from the configuration of embodiment 1.

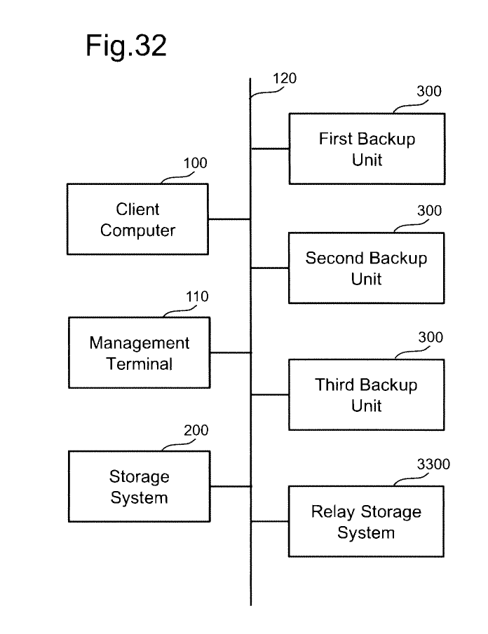

FIG. 32 is a block diagram illustrating a configuration example of the distributed backup system according to embodiment 5.

The client computer 100, the management computer 110, the storage system 200, the multiple backup units 300 and the network 120 are the same as embodiment 1. A relay storage system 3300 is a computer providing a relay restore service to the storage system 200. Now, a relay restore service is a service for receiving the data stored in the n-th backup unit from the n-th backup unit 300, and transmitting the same to the storage system 200.

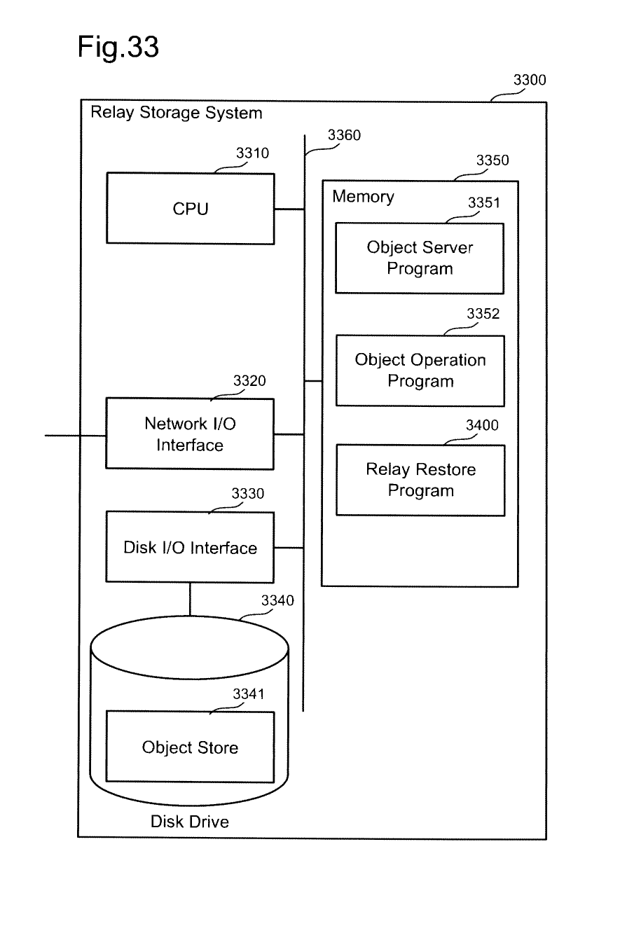

FIG. 33 is a block diagram illustrating a configuration of a relay storage system 3300.

The relay storage system 3300 is a computer having a CPU 3310, a network I/O interface 3320, a disk I/O interface 3330, a disk drive 3340, a memory 3350, and an internal communication channel 3360 (such as a bus) connecting the same.

The CPU 3310 executes the programs stored in the memory 3350. The network I/O interface 3320 is used for the communication between the storage system 200 and the n-th backup unit 300. The disk I/O interface 3330 is used for the communication with the disk drive 3340. The disk drive 3340 is used for storing the data read and written by the relay storage system 3300. The disk drive 3340 stores an object storage 3341. The object storage 3341 is a system for managing data as objects, similar to the object storage 341 of embodiment 1. The memory 3350 stores programs and data. For example, the memory stores an object server program 3351, an object operation program 3352 and a relay restore program 3400.

The object server program 3351 is a program for providing object-unit storage service to the storage system 200, similar to the object server program 1000 according to embodiment 1.

The object operation program 3352 is a program for operating the object stored in the object storage 3341.

The disk drive is shown as the data storage media used by the relay storage system 330, but a SSD (Solid State Drive) can also be used. Further, the storage system 200 is illustrated as a system having a data storage media installed therein, but the system can use an external storage unit in combination therewith. For example, a disk array unit connected via a SAN (Storage Area Network) can be used.

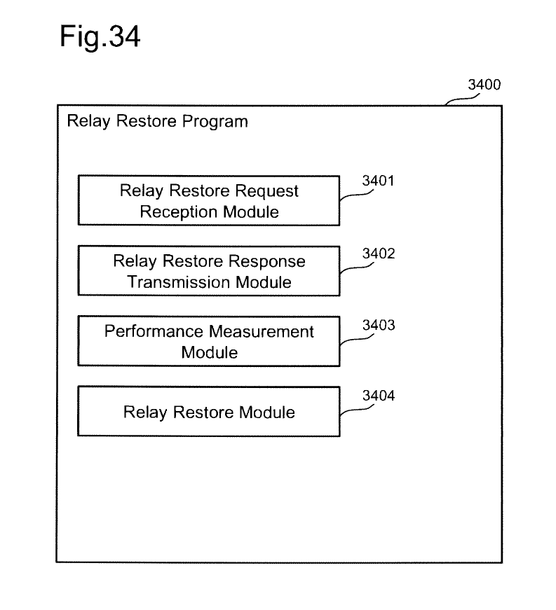

FIG. 34 is a block diagram showing a configuration example of a relay restore program 3400.

The relay restore program 3400 includes a relay restore request reception module 3401, a relay restore response transmission module 3402, a performance measurement module 3403, and a relay restore module 3404.

A relay restore request reception module 3401 is executed when a relay restore request is output from the on-demand restore program 700. The relay restore request reception module 3401 transmits the received restore request to the relay restore module 3404.

The relay restore response transmission module 3402 responds the result of processing of the relay restore request received from the relay restore module 3404 to the on-demand restore program 700.

The performance measurement module 3403 is executed when a performance measurement request is received from the performance measurement module 905 in the storage system 200. The performance measurement module 3403 measures the performance information (response time and bandwidth) among all backup units and the relay storage system 3300, the result of which is sent as a response to the performance measurement module 905.

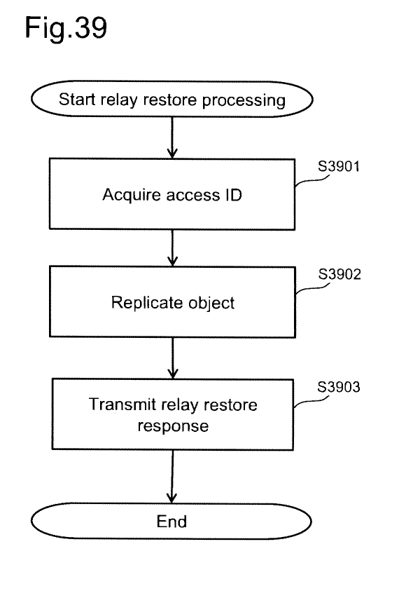

The relay restore module 3404 is executed when a relay restore request is received from the on-demand restore program 700. The relay restore module 3404 acquires the object stored in the n-th backup unit 300 and replicates the same in the object storage 3341. The details of the processing performed by the relay restore module 3404 will be described later with reference to FIG. 39.

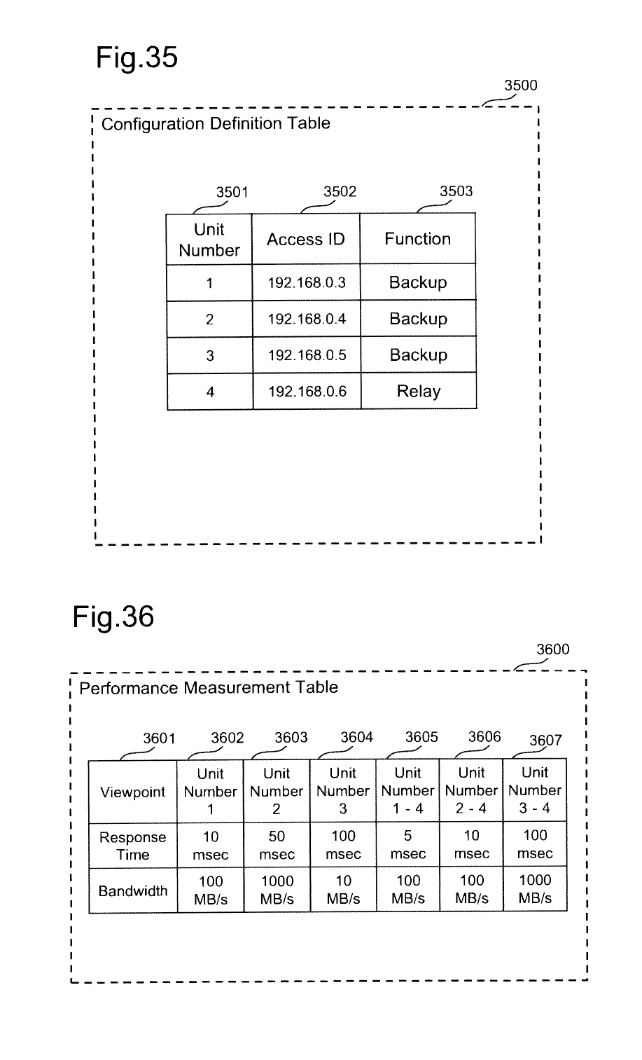

FIG. 35 is a view showing one example of a configuration definition table 3500.

The configuration definition table 3500 includes a unit number 3501, an access ID 3502 and a function 3503. The unit number 3501 and the access ID 3502 are the same as those of embodiment 1. The function 3503 defines whether the function of the computer constituting the distributed backup system is either a backup unit or a relay storage system.

FIG. 36 is a view showing one example of a performance measurement table 3600.

The performance measurement table 3600 includes a viewpoint 3601, and unit numbers 3602, 3603, 3604, 3605, 3606 and 3607. Similar to embodiment 1, the viewpoint 3601 and unit numbers 3602, 3603 and 3604 store performance information related to the communication between the n-th backup unit 300 and the storage system 200. Unit numbers 3605, 3606 and 3607 store performance information including the performance information related to the communication between the relay storage system 3300 and the storage system 200, and the performance information related to the communication between the n-th backup unit 300 and the relay storage system 3300. For example, the response time field of unit number 3605 stores the numerical value having added the response time between the first backup unit and the relay storage system 3300 and the response time between the relay storage system 3300 and the storage system 200. Moreover, the bandwidth field of unit number 3605 stores the smaller bandwidth value of the bandwidth between the first backup unit and the relay storage system 3300 and the bandwidth between the relay storage system 3300 and the storage system 200.

The performance measurement module 905 measures the performance between the n-th backup unit 300 and the storage system 200 via a similar method as embodiment 1, and updates the unit numbers 3602, 3603 and 3604 of the performance measurement table 3600. Further, the performance measurement module 905 transmits a performance measurement request to the relay storage system 3300, and using the performance information between the n-th backup unit 300 and the relay storage system 3300 acquired by the response to the request and the performance information between the relay storage system 3300 and the storage system 200 measured via the performance measurement module 905, the unit numbers 3605, 3606 and 3607 of the performance measurement table 3600 are updated.

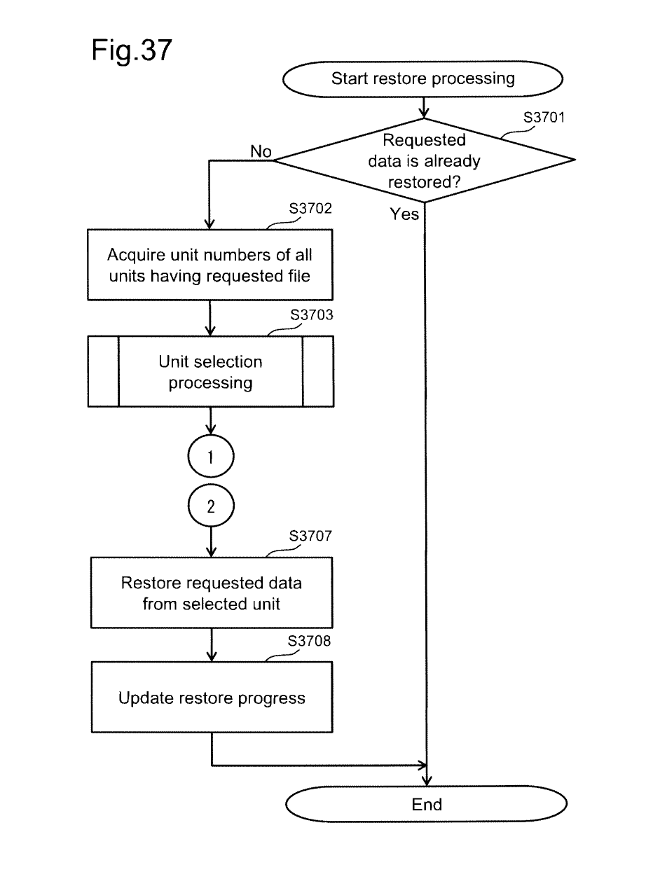

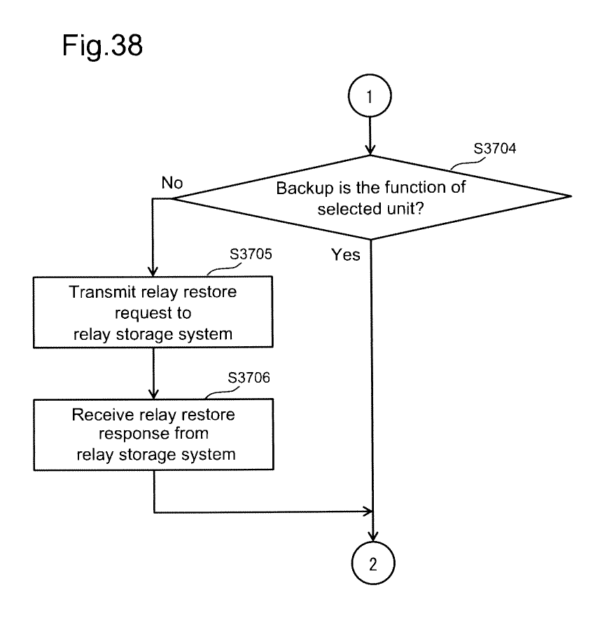

FIGS. 37 and 38 show a flow of processing of a restore module 703.

According to embodiment 5, upon restoration, the operator (such as the administrator) prepares a relay storage system 3300 as the alternative system of the storage system 200, and couples the same to the network 120. Next, the operator uses the management computer 110 to transmit a configuration update request to the configuration definition module 903, and creates a configuration definition table 3500 including the backup unit 300 and the relay storage system 3300. Lastly, the operator transmits an object allocation recovery request to the object allocation management module 904 using the management computer 110, and acquires an object allocation management table 1500 from any of the backup units.

The restore module 703 is executed by the CPU 210 when a restore request is received from the restore request reception module 701. The restore request includes a path of the file or the directory to be restored and a file operation request.

At first, the restore module 703 determines whether or not the requested data is already restored (S3701). If it is determined via a similar method as embodiment 1 that the requested data is already restored in the file system 251 (Yes), the restore processing is completed. If not (No), the restore module 703 advances to S3702.

Next, the restore module 703 acquires the unit numbers of all units including the file or the directory to be restored. Via a method similar to embodiment 1, the restore module 703 acquires the unit numbers of units storing the file or the directory to be restored.

Next, the restore module 703 issues a unit selection request to the backup unit selection program 800 (S3703). After a similar processing as embodiment 1 has been performed as the unit selection processing via the backup unit selection program 800, the restore module 703 obtains a unit selection request including the unit number and type (backup unit or restore unit) of the selected single backup unit, and the procedure advances to S3704.

Next, the restore module 703 determines whether the selected unit is a backup unit or a relay storage system, wherein if the unit is a backup unit (Yes), the procedure advances to S3707, and if the unit is a relay storage system (No), the procedure advances to S3705.

When a relay storage system is selected, the restore module 703 transmits a relay restore request to the relay storage system 3300 (S3705). The relay restore request includes a file ID of the file or the directory to be restored, and an access ID to the unit storing the file or the directory. After the relay restore request is transmitted, the restore module 703 awaits a response from the relay storage system 3300.

Next, the restore module 703 receives a relay restore response from the relay storage system 3300 (S3706). The relay restore response includes the information on whether the restoration of the file or the directory to be restored has been completed or not. When the relay restore response is received, the restore module 703 advances to S3707.

Next, the restore module 703 restores the requested data required for processing the file operation request from the selected unit via a method similar to embodiment 1 (S3707). When the requested data is received from the backup unit, the restore module 703 restores the file or the directory in the file system 251, and advances to S3708.

Next, the restore module 703 updates the restore progress via a similar method as embodiment 1 (S3708). When a response to the restore progress management request is received from the restore progress management module 704, the restore module 703 completes the restore processing.

FIG. 39 is a flow of processing of a relay restore module 3404.

The relay restore module 3404 is executed via the CPU 3310 when a relay restore request is received from the restore module 703. The relay restore request includes a file ID of the file or the directory to be restored, and the access ID to the unit including the file or the directory.

At first, the relay restore module 3404 acquires an access ID to the backup unit as the restore source from the received relay restore request, and sets the same as the access destination backup unit (S3901).

Next, the relay restore module 3404 replicates the object included in the backup unit (S3902). That is, the relay restore module 3404 acquires a file ID of the file or the directory to be replicated from the received relay restore request, and replicates the object that the backup unit has to the object storage 3341.

Next, the relay restore module 3404 transmits to the storage system 200 a response to the relay restore request (S3903), and thereby, the relay restore processing is completed. The relay restore response includes the information on whether relay restoration has succeeded or not.

The above description has illustrated embodiment 5.

According to embodiment 5, when the communication between the backup unit and the storage system is slow, a relay storage system can be used to bypass traffic so as to reduce the time required to restore files or directories. At the same time, when the storage system is busy performing the restore processing, the present embodiment enables to rapidly enhance the redundancy of files or directories deteriorated by the failure of the storage system.

According to embodiment 5, the relay storage system is designed as a storage system that differs from the backup unit, but the relay storage system and the backup unit can also be designed as a single storage system.

According to embodiment 5, a configuration using a single relay storage system has been illustrated, but two or more relay storage systems can also be used. Also in such case, selection can be performed appropriately via the storage system selection program.

According to embodiment 5, the relay storage system is designed as including an object storage, but the relay storage system can have a file system instead of the object storage. When the relay storage system includes a file system, the file ID should be changed to a path, the object server program should be changed to a file server program, and the object operation program should be changed to a file operation program.

### REFERENCE SIGNS LIST

100: Client computer
200: Storage system
300: N-th backup unit (wherein n=1, 2, 3)
400: File server program
500: File operation program
600: Backup program
700: On-demand restore program
800: Backup unit selection program
900: Backup unit management program
1000: Object server program
1100: Object operation program
1200, 3000: Restore progress management table
1300: Unit selection condition setup table
1400, 3500: Configuration definition table
1500, 2900: Object allocation management table
1600, 2400, 3600: Performance measurement table
3300: Relay storage system
3400: Relay restore program

1. A distributed backup system comprising:
a plurality of backup units; and
a storage system including a performance index retention means and a backup unit selection means;
wherein the performance index retention means retains a response time and a bandwidth of each backup unit as the performance index; and
the backup unit selection means
determines whether a transfer size of data being the target of a restore request exceeds a given threshold or not, wherein if the transfer size exceeds the threshold as a result of the determination, selects a backup unit being a transmission source of the restore based on the bandwidth, and if the transfer size falls below the threshold as a result of the determination, selects a backup unit being a transmission source of the restore based on the response time.

2. The distributed backup system according to claim 1, wherein
the backup unit selection means computes an estimated transfer time of each backup unit by adding a value obtained by dividing the response time and the transfer size by the bandwidth, and selects backup units sequentially in the order from the unit having the smallest estimated transfer time.

3. The distributed backup system according to claim 1, wherein the system further comprises:
a user interface unit capable of setting a transfer size as the given threshold.

4. The distributed backup system according to claim 1, wherein
in parallel to the execution of on-demand restore processing, transmission and reception of test data or the execution of batch restore processing is performed to measure performance, and the system further comprises a means for updating the value of the performance index based on the measurement of performance.

5. The distributed backup system according to claim 1, wherein
in order to acquire backup of the file system, the backup unit selection means is operated to select the backup unit as a communication destination for acquiring backup, and the transfer size is set to the transfer size of the data requested for acquiring the backup.

6. The distributed back up system according to claim 5, wherein
a redundancy is set when acquiring the backup; and
the backup unit selection means selects a backup unit including the redundancy set as above.

7. The distributed backup system according to claim 1, wherein upon processing a plurality of restore requests,
the system provides a means for measuring a restore processing performance showing the number of restore operations that can be processed per unit time; and
the backup unit selection means determines whether or not the transfer size exceeds a given threshold, wherein if the size exceeds the threshold, a distribution of the number of restore requests and the selection of the backup unit are determined according to a total amount of restoration calculated for each backup unit based on the bandwidth, and if the size falls below the threshold, a distribution of the number of restore requests and the selection of the backup unit are determined according to the response time and the restore processing performance.

8. The distributed backup system according to claim 7, wherein upon processing a plurality of backup acquisition requests,
the system provides a means for measuring a backup processing performance showing the number of backup operations that can be processed per unit time; and
the backup unit selection means determines whether or not the transfer size exceeds a given threshold, wherein if the size exceeds the threshold, a distribution of the number of backup requests and the selection of the backup unit are determined according to a total amount of backup calculated for each backup unit based on the bandwidth, and if the size falls below the threshold, a distribution of the number of backup requests and the selection of the backup unit are determined according to the response time and the backup processing performance.

9. The distributed backup system according to claim 1, further comprising:
a management means for managing a version of the file system; and
wherein the backup unit selection means sets backup units having a file system of a version to be restored as the target of determination.

10. The distributed backup system according to claim 1, further comprising:
a relay storage system that differs from the storage system and the selected backup unit;
the performance index retention means retains the response time and the bandwidth of the relay storage system as the performance index; and
the backup unit selection means is capable of selecting the relay storage system so as to perform restoration indirectly via the backup unit.

11. The distributed backup system according to claim 10, wherein
the relay storage system is one of the multiple backup units excluding the selected backup unit.

12. The distribution backup system according to claim 10, wherein
if the relay storage system is selected via the backup unit selection means, a relay restore request is transmitted from the storage system to the relay storage system.

13. A restoration method of a distributed backup system comprising:
a step of retaining a response time and a bandwidth of each of multiple backup units;
a step of determining whether a transfer size of data requested for performing restoration exceeds a given threshold or not;
if the transfer size exceeds the threshold as a result of the determination step, a step of selecting a backup unit being a communication source of the restoration based on the bandwidth; and
if the transfer size falls below the threshold as a result of the determination step, a step of selecting a backup unit being a communication source of the restoration based on the response time.

14. The restoration method of a distributed backup system according to claim 13, wherein
a relay restore system is added as a target of retaining the response time and the bandwidth; and
the method further comprises a step of transmitting a relay restore request to the relay restore system when the relay restore system is selected in the step of selecting the backup unit.
